(19) United States
(12) Patent Application Publication
(10) Pub. No.: US 2026/0080669 A1
(43) Pub. Date: Mar. 19, 2026

(54) SYSTEMS AND METHODS FOR EFFICIENT DATASET DISTILLATION WITH ATTENTION MATCHING

(71) Applicant: ROYAL BANK OF CANADA, Toronto (CA)

(72) Inventors: Ahmad SAJEDI, Toronto (CA); Ehsan AMJADIAN, Toronto (CA); Samir KHAKI, Toronto (CA); Lucy Z. LIU, Toronto (CA); Yuri LAWRYSHYN, Toronto (CA); Konstantinos N. PLATANIOTIS, Toronto (CA)

(21) Appl. No.: 18/888,893

(22) Filed: Sep. 18, 2024

(51) Int. Cl. G06V 10/82; G06V 10/75; G06V 10/77

(52) U.S. Cl. CPC G06V 10/82; G06V 10/751; G06V 10/7715

(57) ABSTRACT

Systems and methods proposed herein are directed to an improved approach and corresponding data architecture for generating condensed synthetic sets using a dataset distillation with attention matching (DataDAM) approach that matches spatial attention maps of real and synthetic data generated by different layers within a family of randomly initialized neural networks.

### FIELD

Embodiments of the present disclosure relate to the field of computer implemented artificial intelligence/simulation and modelling machine learning, and more specifically, embodiments relate to devices, systems and methods for dataset distillation augmented with attention matching to improve generation of condensed synthetic datasets that maintain performance that can be used to reduce training costs/time relative to training on the original training data.

### INTRODUCTION

A challenge with using synthetic dataset, especially a smaller data set relative to the training data set, is that there can be performance issues, namely that using the synthetic data set, there can be issues with distribution and thus the utility of the data set is reduced in terms of an ability to classify/discriminate. Using a full training set, on the other hand, has significant computational costs.

There is a desire to improve dataset generation approaches.

### SUMMARY

Systems and methods proposed herein are directed to an improved approach and corresponding data architecture for generating condensed synthetic sets using a dataset distillation with attention matching (DataDAM) approach that matches spatial attention maps of real and synthetic data generated by different layers within a family of randomly initialized neural networks. Applicants conducted testing across reference datasets and found a measurable improvement. The system can also be provided in the form of corresponding computer program products (non-transitory computer readable media having computer instructions stored thereon).

Deep learning is employed in various fields such as computer vision and natural language processing, due to the use of large-scale datasets and modern Deep Neural Networks (DNNs). However, extensive infrastructure resources required for training, hyperparameter tuning, and architectural searches make it challenging to reduce computational costs while maintaining comparable performance. The systems and methods proposed herein can be used for image generation, but are not limited to such applications. In the image use case, high quality distilled images can be used for practical benefits for downstream applications, such as continual learning or neural architecture search.

As described herein, the approach includes utilizing generated spatial attention map data structures (one corresponding to real data, and one corresponding to synthetic data). An improved computing architecture is provided where the computing architecture includes a plurality of different layers of randomly initialized neural networks, which is used to generate the data sets. The spatial attention maps that are generated can then be used by a computational process to “learn” synthetic images by way of conducting a matching function of the special attention maps.

The DataDAM approach can outperform existing methods by overcoming computational problems. The DataDAM approach is directed to a computational method that does not rely on pre-trained network parameters or employ bi-level optimization. It is thus possible to generate an unbiased representation of the real data distribution. This approach reduces computational costs and enable cross-architecture generalizations.

The DataDAM approach extracts meaningful representations from real and synthetic datasets by leveraging the effectiveness of randomly initialized networks to generate representations that establish a distance-preserving embedding of the data. The method aligns the most discriminative feature maps using the Spatial Attention Matching (SAM) module and minimizes the distance between them with the MSE loss. It further reduces the last-layer feature distribution disparities between the two datasets with a complementary loss as a regularizer.

The distilled data can enhance downstream applications by improving memory efficiency for continual learning and accelerating neural architecture search through a more representative proxy dataset. This approach lowers training costs without sacrificing performance. With a same amount of computing/processing capability available, an improved quality of synthetic data is possible (e.g., for intrinsic or extrinsic approaches). For example, with fewer data points, a higher performing model (e.g., F score, accuracy) is possible. Where there are a same number of images, there can be an improved space and time complexity in both training and evaluation (e.g., decreased complexity). Further, from a privacy perspective, sensitive images may not wish to be used for model training. This approach can be utilized to create synthetic data where privacy issues are not as prevalent. The approach can also be used to reduce bias towards a specific example, and this is useful for applications that are sensitive to bias.

From a practical application perspective, it is important to train models quickly in an efficient approach. There are two aspects described herein: NAS and continuations learning. In NAS, to find the best model where there is a large search space for learning a model (e.g., 500 different models), it can be very hard from a training perspective. DataDAM can be used to generate the synthetic images first. The synthetic images are highly correlated to the original data set.

A specific type of image that works well with the approach includes aerial images at a high level of resolution. For example, a specific use case includes adding satellite images to house/map information, and Applicants find that being able to reduce and compress the images assists in speeding up a training cycle, as the system does not have to retrain on images, and rather, a smaller set of these images can be used to train a joint model that has, for example, image and tabular data.

An example practical implementation includes providing the approach as a dataset distillation system at a data center that receives inputs through a message bus or application programming interface, where the input can be a stream of images or an image data set, and the output is the generated images (e.g., compressed by reducing the total number of images). The generated output is useful for training bias and improving privacy, and in some embodiments, can be directly provided into a downstream system for privacy enhanced, or resource constrained (e.g., a model training being conducted on a portable device) applications. The approach described herein can be used to generate images where bias and correlation are considered, and addressed using different regularization techniques. For example, for regularization (e.g., dropout to mitigate the bias of the original data set especially with the synthetic dataset), pre-processing such as data augmentation and dropout can be applied. Observing synthetic data, one can use the average statistical properties. In a specific example, there may be a class “dog”, which can have different heads of class “dog”. The approach can include averaging over all the images, recognizing, in this example, that the “class dog” has a head, and there can different breeds as the correlation is not high (e.g., not 90%) but the correlation is enough so that it is similar. The approach effectively is a computational approach that attempts to learns to synthesize images, not picking images from random.

In terms of practical applied use cases integrating with other computing systems and mechanisms, the approach can be used as a special purpose computing system, such as a specialized computer server or computing appliance in a data center, that operates as a black box model that receives input training data sets and generates condensed synthetic data sets that can be comprised of image data. As the condensed synthetic data sets have a reduced number of elements, the training can be done more efficiently (for situations where one does not have a large number of GPUs or images), and the approach can also be used to address issues in the training data set (e.g., avoiding privacy issues, bias, etc.). The special purpose computing system can be used for continuous (e.g., instead of training on a full pipeline training set, the pipeline is condensed using the system first and then provided to the downstream system) or federated learning (where instead of sending weights, the system is used to generate synthetic datasets (based, for example, on a distillation ratio), to be used for central training. The synthetic condensed datasets are provided back to a central controller for central training. This approach can use multiple instances of the system (e.g., one each for each training engine) described herein or a subset of instances shared across multiple training engines that can be adapted based on load management and distribution.

In another variation, such as for continuous training, in addition to pipeline compression, the images can be also or alternatively be used to mitigate a forgetting problem by using the engine to save a subset of synthetic images that are used for downstream re-training, or to establish a curriculum training approach. For example, on day 1, the system is configured to train all of the models using the training data, and on a next day—the system can then re-train using the synthetic images generated in accordance with an approach proposed herein, which can be more informative. This approach helps avoid catastrophic forgetting, and in some embodiments, periodic training can be used to makes it highly affordable—this approach can be used to anchor the model training in an attempt to avoid drift.

Additional variations are possible where both a training set and a synthetic data set, or multiple synthetic data sets are used for training simultaneously. The system can be used as a useful tool to aid in model selection. In the model selection practical application, the system is utilized to reduce the overall computational burden when testing multiple models (or the same model with different hyperparameters for tuning) for performance. This is an expensive process to be undertaken during the initial architecture and design phase of a machine learning system. It can take months, even with strong GPUs available. The system is used as a pre-input stage to generate smaller data sets for the selection phase to compress the dataset, and can be used multiple times to re-compress the dataset using the DataDAM engine (e.g., compress 5 times->80% smaller or 90% smaller). The compressed dataset can then be used to test all of the datasets, so that it can be used for an automated expedited architecture search process.

Finally, the system can be utilized for applied use cases to reduce privacy concerns, which is a major consideration for financial institutions as client images are highly sensitive and protected. The synthetic images can be used, for example, as a fraud model (e.g., identifying fraudsters) while not using client images directly to add an additional step of privacy. Similarly, the system can not only be used for human images, but also for check image processing, where a datasets of valid checks for a particular financial institution can be used to generate a synthetic training set for fraudulent check determination.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1A is an architecture diagram showing an illustration of the proposed DataDAM method, according to some embodiments. DataDAM includes a Spatial Attention Matching (SAM) module to capture the dataset's distribution and a complementary loss for matching the feature distributions in the last layer of the encoder network. In FIG. 1B, the internal architecture and corresponding process of the SAM module is shown, according to some embodiments.

FIG. 2A is a distribution diagram and FIG. 2B is a graph of testing accuracy.

FIG. 3 is a graph that shows test accuracy evolution of synthetic image learning on CIFAR10 with IPC50 under three different initializations: Random, K-Center, and Gaussian noise, according to some embodiments.

FIG. 4 is a graph that shows the effect of task balance A on the testing accuracy (%) for CIFAR10 dataset with IPC10 configuration, according to some embodiments.

FIG. 5 is a rendering showing of distributions of synthetic images learned by four methods on CIFAR10 with IPC50. The stars represent the synthetic data dispersed amongst the original training dataset.

FIG. 6A-6D show samples from the described method's learned synthetic images for different resolutions.

FIG. 7A and FIG. 7B shows that the memory construction approach proposed herein consistently outperforms others in both settings.

FIG. 8 is a graph showing the effect of the power parameter p on the final testing accuracy (%) for the CIFAR10 dataset with IPC 10 configuration.

FIG. 9 is a graph showing test accuracy evolution of synthetic image learning on CIFAR10 with IPC 50 under Gaussian noise initialization.

FIG. 10 is a graph showing the learning process of all classes in the CIFAR10 dataset (IPC 50) initialized from Gaussian noise.

FIG. 11 is a graph showing the effect of different augmentation strategies during the evaluation phase on the final testing accuracy (%) for the CIFAR10 dataset with IPC 10 configuration.

FIG. 12 is a graph showing the effect of loss configurations of LSAM on the final testing accuracy (%) for the CIFAR10 dataset with IPC 10 configuration.

FIG. 13 is a graph showing the effect of different normalization blocks of the SAM module on the final testing accuracy (%) for the CIFAR10 dataset with IPC 10 configuration.

FIG. 14 shows performance rank correlation between proxy set and whole dataset training across all 720 architectures.

FIG. 15 is a graph showing performance rank correlation between proxy-set and whole-dataset training across the top 20% of the search space (selecting 144 architectures with the highest validation accuracy).

FIG. 16 shows distributions of the synthetic images learned by five methods on the CIFAR10 dataset with IPC 50.

FIG. 17 is a computer block schematic diagram showing an example computer system configured for distilling a first input dataset to generate a condensed synthetic dataset.

FIG. 18 is a block schematic of an example computer system, according to some embodiments.

### DETAILED DESCRIPTION

An approach to reduce training costs is to take a data-centric approach, which concentrates smaller datasets with enough information for training. An example data-centric approach is the coreset selection method, which selects a representative subset of an original dataset. However, these methods have limitations as they rely on heuristics to generate a coarse approximation of the whole dataset, which may lead to a suboptimal solution for downstream tasks like image classification.

Dataset distillation (or condensation), a more recent alternative, distills knowledge from a large training dataset into a smaller synthetic set such that a model trained on it achieves competitive testing performance with one trained on the real dataset. The condensed synthetic sets contain valuable information, making them a popular choice for various machine learning applications like continual learning, neural architecture search, federated learning, and privacy preserving tasks. Dataset distillation approaches use bi-level meta-learning to optimize model parameters on synthetic data in the inner loop and refine the data with meta-gradient updates to minimize the loss on the original data in the outer loop.

Various methods have been proposed to overcome the computational expense of this method, including approximating the inner optimization with kernel methods, surrogate objectives like gradient matching, trajectory matching, and distribution matching. The kernel-based methods and gradient matching work still require bi-level optimization and second-order derivation computation, making training a difficult task. Trajectory matching demands significant GPU memory for extra disk storage and expert model training.

Prior methods use dynamic bi-level optimization with layer-wise feature alignment, which can generate biased images and incur a significant time cost. Accordingly, these methods are not scalable for larger datasets such as ImageNet-1K. Distribution matching (DM) was proposed as a scalable solution for larger datasets by skipping optimization steps in the inner loop. However, DM usually underperforms compared to prior methods.

A computational approach is described herein to establish a novel end-to-end framework which leverages attention maps to synthesize data that closely approximates the real training data distribution, described as Dataset Distillation with Attention Matching (DataDAM). Dataset Distillation.

Dataset distillation was introduced by expressing network parameters as a function of synthetic data and optimizing the synthetic set to minimize the training loss on real training data. Later developments extended this approach with soft labels and a generator network. Researchers have proposed simplifying the neural network model in bi-level optimization using kernel methods, such as ridge regression, which has a closed-form solution, and a kernel ridge regression model with Neural Tangent Kernel (NTK) that approximates the inner optimization.

Alternatively, some studies have utilized surrogate objectives to address unrolled optimization problems. Dataset condensation (DC) and DCC generate synthetic images by matching the weight gradients of neural networks on real and distilled training datasets, while other methods improve gradient matching with data augmentation. MTT matches model parameter trajectories trained with synthetic and real datasets, and CAFE and DM match features generated by a model using distilled and real datasets.

However, these methods have limitations, including bi-level optimization, second-order derivative computation, generating biased examples, and massive GPU memory demands. In contrast, the described approach of various claimed embodiments herein is adapted to conduct an approach that matches the spatial attention map in intermediate layers, reducing memory costs while outperforming alternate methods on standard benchmarks.

Coreset selection is another datacentric approach that chooses a representative subset of an original dataset using heuristic selection criteria. For example, random selection selects samples randomly; herding selects the samples closest to the cluster center for each class center; K-Center chooses multiple center points of a class to minimize the maximum distance between data points and their nearest center point; and forgetting identifies training samples that are easily forgotten during the training process.

However, heuristics-based methods may not be optimal for downstream tasks like image classification, and finding an informative coreset may be challenging when the dataset's information is not concentrated in a few samples. The approach herein learns a computationally efficient synthetic set that is not limited to a subset of the original training samples.

Attention mechanisms are an approach used in deep learning to improve performance on various tasks with initial applications in natural language processing for language translation. Attention has since been used in computer vision, with global attention models for improved classification accuracy on image datasets and convolutional block attention modules for learning to attend to informative feature maps. Attention has also been used for model compression in knowledge distillation However, this mechanism has not been explored in the context of dataset distillation. To fill this gap, the approach herein uses a spatial attention matching module to approximate the distribution of the real dataset.

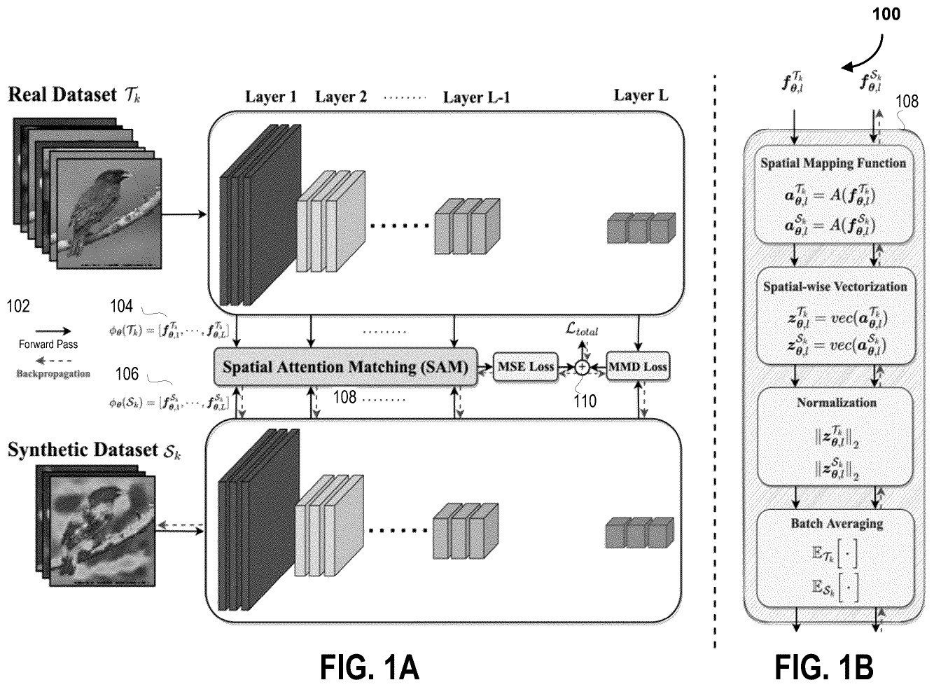

FIG. 1A is an architecture diagram showing an illustration of the proposed DataDAM method, according to some embodiments. DataDAM includes a Spatial Attention Matching (SAM) module to capture the dataset's distribution and a complementary loss for matching the feature distributions in the last layer of the encoder network. In FIG. 1B, the internal architecture and corresponding process of the SAM module is shown, according to some embodiments.

Dataset Distillation with Attention Matching (DataDAM) is an end-to-end framework that leverages attention maps to synthesize data that approximates the real training data distribution.

The high dimensionality of training images makes it difficult to estimate the real data distribution accurately.

Each training image is represented using spatial attention maps generated by different layers within a family of randomly initialized neural networks.

These maps highlight the most discriminative regions of the input image that the network focuses on at different layers (early, intermediate, and last layers) while capturing low-, mid-, and high-level representation information of the image. Although each individual network provides a partial interpretation of the image, the family of these randomly initialized networks produces a more comprehensive representation.

The system shown in 100 is configured to capture the initial dataset's distribution and a complementary loss for matching the feature distributions of the datasets.

Dataset Distillation with Attention Matching: Given a large-scale dataset

$$𝒯 = {\{ ( {x}_{i} , {y}_{i} ) \}}_{i = 1}^{\vert 𝒯 \vert}$$

containing | [symbol] | real image-label pairs, a learnable synthetic datasci

$$𝒮 = {\{ ( {s}_{j} , {y}_{j} ) \}}_{j = 1}^{\vert 𝒮 \vert}$$

is first initialized with | [symbol] | synthetic image and label pairs by using either random noise or a selection of real images obtained through random sampling or a clustering algorithm such as K-Center.

A neural network φ_{θ}(·) consisting of L layers 102 is configured with standard network random initialization θ to extract features from batches of each dataset

$$( {B}_{k}^{𝒯} and {B}_{k}^{𝒮} , resp . ) ,$$

sampled for each class k.

The neural network φ_{θ}(·) 102 consisting of L layers, is employed to embed the real and synthetic sets. The network generates feature maps for each dataset, represented as

$${ϕ}_{θ} ( {𝒯}_{k} ) = [ {f}_{θ , 1}^{{𝒯}_{k}} , … , {f}_{θ , L}^{{𝒯}_{k}} ] and {ϕ}_{θ} ( {𝒮}_{k} ) = [ {f}_{θ , 1}^{{𝒮}_{k}} , … , {f}_{θ , L}^{{𝒮}_{k}} ] ,$$

The feature

$${f}_{θ , l}^{{𝒯}_{k}}$$

is a multi-dimensional array in

$${ℝ}^{\vert {B}_{k}^{𝒯} \vert \times {C}_{l} \times {W}_{l} \times {H}_{l}} ,$$

coming from the real dataset in the l^{th} layer, where Cₗ represents the number of channels and Hₗ×Wₗ is the spatial dimensions. Similarly, a feature

$${f}_{θ , l}^{{𝒮}_{k}}$$

106 Is extracted for the synthetic set.

The Spatial Attention Matching (SAM) module 108 generates attention maps for the real and synthetic images using a feature-based mapping function A(·). The function takes the feature maps of each layer (except the last layer) as an input and outputs two separate attention maps

$$A ( {ϕ}_{θ} ( {𝒯}_{k} ) ) = [ {a}_{θ , 1}^{{𝒯}_{k}} , … , {a}_{θ , L - 1}^{{𝒯}_{k}} ] and A ( {ϕ}_{θ} ( {𝒮}_{k} ) ) = [ {a}_{θ , 1}^{{𝒮}_{k}} , … , {a}_{θ , L - 1}^{{𝒮}_{k}} ]$$

for the real and synthetic sets, respectively. A spatial attention map is created by aggregating the absolute values of the feature maps across the channel dimension. The feature map

$${f}_{θ , l}^{{𝒯}_{k}}$$

104 of the l^{th} layer is converted into a spatial attention map

$${a}_{θ , 1}^{{𝒯}_{k}} ∈ {ℝ}^{\vert {B}_{k}^{𝒯} \vert \times {W}_{l} \times {H}_{l}}$$

using the following pooling operation:

$$( {f}_{θ , l}^{{𝒯}_{k}} ) = {\sum }_{i = 1}^{{C}_{l}} {\vert {( {f}_{θ , l}^{{𝒯}_{k}} )}_{i} \vert}^{p} , \qquad ( Equation 1 )$$

$$where , {( {f}_{θ , l}^{{𝒯}_{k}} )}_{i} = {f}_{θ , l}^{{𝒯}_{k}} ( : , i , : , : )$$

is the feature map of channel i from the lth layer and the power and absolute value operations are applied element-wise. The resulting attention map emphasizes the spatial locations associated with neurons with the highest activations. This helps retain the most informative regions and generates a more efficient feature descriptor. The attention maps for synthetic data can be obtained as

$${a}_{θ , l}^{{𝒮}_{k}} .$$

To capture the distribution of the original training set at different levels of representations, the normalized spatial attention maps of each layer (excluding the last layer) between the real and synthetic sets are compared using the loss function [symbol] which is formulated as

$${𝔼}_{θ \sim {P}_{θ}} [ {\sum }_{k = 1}^{K} {\sum }_{l = 1}^{L - 1} {‖ {𝔼}_{{𝒯}_{k}} [ \frac{{z}_{θ , l}^{{𝒯}_{k}}}{{‖ {z}_{θ , l}^{{𝒯}_{k}} ‖}_{2}} ] - {𝔼}_{{𝒮}_{k}} [ \frac{{z}_{θ , l}^{{𝒮}_{k}}}{{‖ {z}_{θ , l}^{{𝒮}_{k}} ‖}_{2}} ] ‖}^{2} ] , \qquad ( Equation 2 )$$

$$where , {z}_{θ , l}^{{𝒯}_{k}} = v e c ( {a}_{θ , l}^{{𝒯}_{k}} ) ∈ {ℝ}^{\vert {B}_{k}^{𝒯} \vert \times ( {W}_{l} \times {H}_{l} )} and {z}_{θ , l}^{{𝒮}_{k}} = v e c ( {a}_{θ , l}^{{𝒮}_{k}} ) ∈ {ℝ}^{\vert {B}_{k}^{S} \vert \times ( {W}_{l} \times {H}_{l} )}$$

are the lth pair of vectorized attention maps along the spatial dimension for the real and synthetic sets, respectively. The parameter K is the number of categories in a dataset, and P_{θ} denotes the distribution of network parameters. Normalization of the attention maps in the SAM module improves performance on the syntactic set.

Despite the ability of [symbol] to approximate the real data distribution, a discrepancy still exists between the synthetic and real training sets. The features in the final layer of neural network models encapsulate the highest-level abstract information of the images in the form of an embedded representation, which has been shown to effectively capture the semantic information of the input data. A complementary loss 110 is leveraged as a regularizer to promote similarity in the mean vectors of the embeddings between the two datasets for each class. Maximum Mean Discrepancy (MMD) loss, [symbol] is employed. [symbol] is calculated within a family of kernel mean embeddings in a Reproducing Kernel Hilbert Space (RKHS). The [symbol] loss is formulated as

$${𝔼}_{θ \sim {P}_{θ}} [ {\sum }_{k = 1}^{K} {‖ {𝔼}_{{𝒯}_{k}} [ {\tilde{f}}_{θ , L}^{{𝒯}_{k}} ] - {𝔼}_{{𝒮}_{k}} [ {\tilde{f}}_{θ , L}^{{𝒮}_{k}} ] ‖}_{ℋ}^{2} ] , \qquad ( Equation 3 )$$

where [symbol] is a reproducing kernel Hilbert space. The

$${\tilde{f}}_{θ , L}^{{𝒯}_{k}} = v e c ( {f}_{θ , L}^{{𝒯}_{k}} ) ∈ {ℝ}^{\vert {B}_{k}^{𝒯} \vert \times ( {C}_{L} \times {W}_{L} \times {H}_{L} )} and {\tilde{f}}_{θ , L}^{{𝒮}_{k}} = v e c ( {f}_{θ , L}^{{𝒮}_{k}} ) ∈ {ℝ}^{\vert {B}_{k}^{𝒮} \vert \times ( {C}_{L} \times {W}_{L} \times {H}_{L} )}$$

are the final feature maps of the real and synthetic sets in vectorized form with both the channel and spatial dimensions included. The expectation terms are estimated in Equations 2 and 3 empirically if ground-truth data distributions are not available.

The synthetic dataset is learned by solving the following optimization problem using SGD with momentum:

$$𝒮 = {arg min}_{𝒮} ( {ℒ}_{S A M} + {λℒ}_{M M D} ) , \qquad ( Equation 4 )$$

where λ is the task balance parameter This approach assigns a fixed label to each synthetic sample and keeps it constant during training. A summary of the learning algorithm can be found in Algorithm 1.

Algorithm 1. Dataset Distillation with Attention Matching:
$Input \text{:} Real training dataset 𝒯 = {\{ ( {x}_{i} , {y}_{i} ) \}}_{i = 1}^{\vert 𝒯 \vert}$
Required: Initialized synthetic samples for K classes, Deep neural network φ_{θ} with
parameters θ, Probability distribution over randomly initialized weights P_{θ}, Learning rate [symbol] ,
Task balance parameter λ, Number of training iterations I.
1: Initialize synthetic dataset [symbol]
2: for i = 1, 2, · · · , / do
3: Sample θ from P_{θ}
$4 \text{:} Sample mini - batch pairs {B}_{k}^{𝒯} and {B}_{k}^{𝒮} from$
the real and synthetic sets for each class k
5: Compute [symbol] _{SAM} and [symbol] _{MMD} using Equations 2 and 3
6: Calculate [symbol] = [symbol] _{SAM} + λ [symbol] _{MMD}
7: Update the synthetic dataset using [symbol] ← [symbol] − [symbol] [symbol] [symbol]
8: end for
$Output \text{:} Synthetic dataset 𝒮 = {\{ ( {s}_{i} , {y}_{i} ) \}}_{i = 1}^{\vert 𝒮 \vert}$

### Testing Results

Based on embodiments of the present disclosure discussed above, results of experiments showing advantages over the existing art are provided.

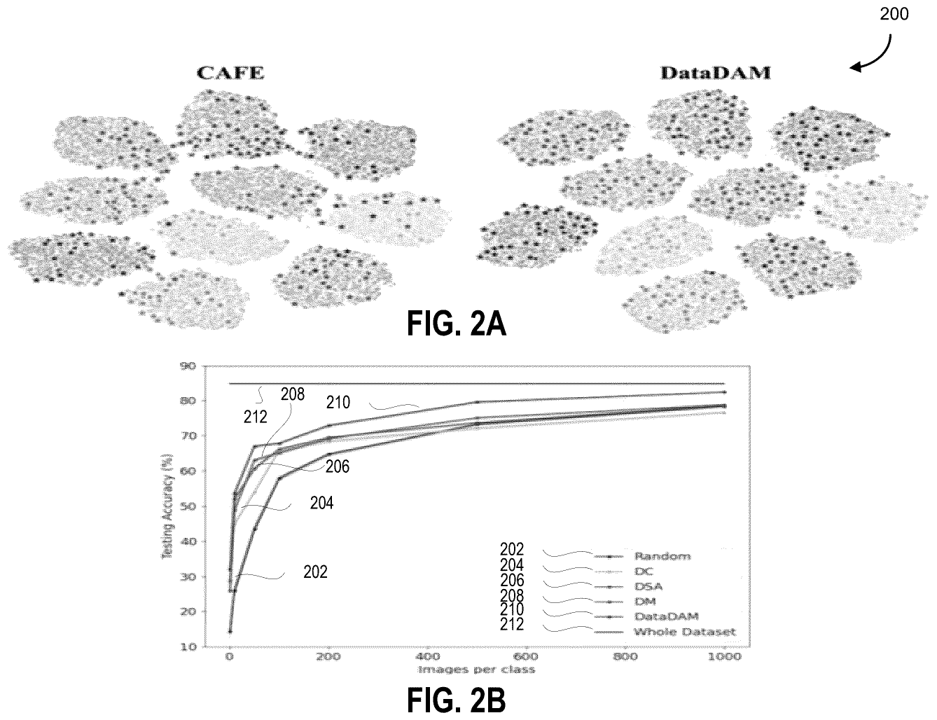

The method described herein does not rely on pre-trained network parameters or employ bi-level optimization, making it a tool for synthetic data generation, where the generated synthetic dataset does not introduce any bias into the data distribution while outperforming concurrent methods as shown in FIG. 2.

FIG. 2A is a distribution diagram and FIG. 2B is a graph of testing accuracy. FIG. 2A and FIG. 2B shows (a) Data distribution of the distilled images on the CIFAR10 dataset with 50 images per class (IPC50) for CAFE and DataDAM, and (b) a performance comparison with state-of-the-art methods on the CIFAR10 dataset for varying IPCs shown as 202, 204, 206, 208, 210, and 212.

The performance of an implementation of the present disclosure has been evaluated on CIFAR10/100 datasets, which have a resolution of 32×32, in line with state-of-the-art benchmarks.

For medium-resolution data, the Tiny ImageNet and ImageNet-1K datasets were resized to 64×64. Previous work on dataset distillation introduced subsets of ImageNet-1K that focused on categories and aesthetics, including assorted objects, dog breeds, and birds. To conduct the experiments, these subsets, namely ImageNette, ImageWoof, and ImageSquawk, which consist of 10 classes, were utilized as high-resolution (128×128) datasets.

Network Architectures: A ConvNet architecture was used for the distillation task. The default ConvNet has three identical convolutional blocks and a linear classifier. Each block includes a 128-kernel 3×3 convolutional layer, instance normalization, ReLU activation, and 3×3 average pooling with a stride of 2. The network for medium- and high-resolution data was adjusted by adding a fourth and fifth convolutional block to account for the higher resolutions, respectively. In all experiments, the network parameters were initialized using normal initialization.

The methods were evaluated using standard measures from prior studies. Five sets of small synthetic images using 1, 10, and 50 images per class (IPC) were generated from a real training dataset. Next, 20 neural network models were trained on each synthetic set using an SGD optimizer with a learning rate of 0.01. The mean and standard deviation over 100 models for each experiment were used to assess the effectiveness of the performance of distilled datasets. Computational costs were evaluated using run-time expressed per step, averaged over 100 iterations, and peak GPU memory usage during 100 iterations of training. The visualizations of the unbiasedness of state-of-the-art methods used t-SNE visualization.

The method was evaluated against four coreset selection approaches and eight advanced methods for training set synthesis. The coreset selection methods include Random selection, Herding, K-Center, and Forgetting. The approach was compared with state-of-the-art distillation methods, including Dataset Distillation (DD), Flexible Dataset Distillation (LD), Dataset Condensation (DC), Dataset Condensation with Differentiable Siamese Augmentation (DSA), Distribution Matching (DM), Aligning Features (CAFE), Kernel Inducing Points (KIP), and Matching Training Trajectories (MTT). To ensure reproducibility, publicly available distilled data for each baseline method was downloaded and the trained models using the experimental setup. Minor adjustments were made to some methods to ensure a fair comparison, and for those that did not conduct experiments on certain data, they were implemented using the released author codes.

Performance Comparison: The method described herein was compared with selection—and synthesis-based approaches in Tables 1 and 2. The results demonstrate that training set synthesis methods outperform coreset methods, especially when the number of images per class is limited to 1 or 10. This is due to the fact that synthetic training data is not limited to a specific set of real images. Moreover, the method described herein consistently outperforms all baselines in most settings for low-resolution datasets, with improvements on the top competitor, MTT, of 1.1% and 6.5% for the CIFAR10/100 datasets when using IPC50.

This indicates that DataDAM can achieve up to 88% of the upper-bound performance with just 10% of the training dataset on CIFAR100 and up to 79% of the performance with only 1% of the training dataset on CIFAR10. For medium- and high-resolution datasets, including Tiny ImageNet, ImageNet-1K, and ImageNet subsets, DataDAM also surpasses all baseline models across all settings.

While existing methods fail to scale up to the ImageNet-1K due to memory or time constraints, DataDAM achieved accuracies of 2.0%, 2.2%, 6.3%, and 15.5% for 1, 2, 10, and 50 IPC, respectively, surpassing DM and Random by a significant margin. This improvement can be attributed to the described methodology, which captures essential layer-wise information through spatial attention maps and the feature map of the last layer. Ablation studies provide further evidence that the performance gain is directly related to the discriminative ability of the method in the synthetic image learning scheme.

TABLE 1
The performance (testing accuracy %) comparison to state-of-the-art methods. The given number
of images per class are distilled using the training set, a neural network is trained on
the synthetic set from scratch, and the network is evaluated on the testing data.

| | | | | Coreset Selection | | | |
|---|---|---|---|---|---|---|---|
| | IPC | Ratio % | Resolution | Random | Herding | K-Center | Forgetting |
| CIFAR-10 | 1 | 0.02 | 32 | 14.4 ± 2.0 | 21.5 ± 1.2 | 21.5 ± 1.3 | 13.5 ± 1.2 |
| | 10 | 0.2 | 32 | 26.0 ± 1.2 | 31.6 ± 0.7 | 14.7 ± 0.9 | 23.3 ± 1.0 |
| | 50 | 1 | 32 | 43.4 ± 1.0 | 40.4 ± 0.6 | 27.0 ± 1.4 | 23.3 ± 1.1 |
| CIFAR-100 | 1 | 0.2 | 32 | 4.2 ± 0.3 | 8.3 ± 0.3 | 8.4 ± 0.3 | 4.5 ± 0.2 |
| | 10 | 2 | 32 | 14.6 ± 0.5 | 17.3 ± 0.3 | 17.3 ± 0.3 | 15.1 ± 0.3 |
| | 50 | 10 | 32 | 30.0 ± 0.4 | 33.7 ± 0.5 | 30.5 ± 0.3 | — |
| Tiny | 1 | 0.2 | 64 | 1.4 ± 0.1 | 2.8 ± 0.2 | — | 1.6 ± 0.1 |
| ImageNet | 10 | 2 | 64 | 5.0 ± 0.2 | 6.3 ± 0.2 | — | 5.1 ± 0.2 |
| | 50 | 10 | 64 | 15.0 ± 0.4 | 16.7 ±\|0.3 | — | 15.0 ± 0.3 |

| Training Set Synthesis | | | | | | | | | Whole |
|---|---|---|---|---|---|---|---|---|---|
| DD^{†}[ [symbol] ] | LD^{†} [ [symbol] ] | DC [ [symbol] ] | DSA [ [symbol] ] | DM [ [symbol] ] | CAFE [ [symbol] ] | KIP [ [symbol] ] | MTT [ [symbol] ] | DataDAM | Dataset |
| — | 25.7 ± 0.7 | 28.3 ± 0.5 | 28.8 ± 0.7 | 26.0 ± 0.8 | 31.6 ± 0.8 | 29.8 ± 1.0 | 31.9 ± 1.2 | 32.0 ± 1.2 | 84.8 ± 0.1 |
| 36.8 ± 1.2 | 38.3 ± 0.4 | 44.9 ± 0.5 | 52.1 ± 0.5 | 48.9 ± 0.6 | 50.9 ± 0.5 | 46.1 ± 0.7 | 56.4 ± 0.7 | 54.2 ± 0.8 | |
| — | 42.5 ± 0.4 | 53.9 ± 0.5 | 60.6 ± 0.5 | 63.0 ± 0.4 | 62.3 ± 0.4 | 53.2 ± 0.7 | 65.9 ± 0.6 | 67.0 ± 0.4 | |
| — | 11.5 ± 0.4 | 12.8 ± 0.3 | 13.9 ± 0.3 | 11.4 ± 0.3 | 14.0 ± 0.3 | 12.0 ± 0.2 | 13.8 ± 0.6 | 14.5 ± 0.5 | 56.2 ± 0.3 |
| — | — | 25.2 ± 0.3 | 32.3 ± 0.3 | 29.7 ± 0.3 | 31.5 ± 0.2 | 29.0 ± 0.3 | 33.1 ± 0.4 | 34.8 ± 0.5 | |
| — | — | 30.6 ± 0.6 | 42.8 ± 0.4 | 43.6 ± 0.4 | 42.9 ± 0.2 | — | 42.9 ± 0.3 | 49.4 ± 0.3 | |
| — | — | 5.3 ± 0.1 | 5.7 ± 0.1 | 3.9 ± 0.2 | — | — | 6.2 ± 0.4 | 8.3 ± 0.4 | 37.6 ± 0.4 |
| — | — | 12.9 ± 0.1 | 16.3 ± 0.2 | 12.9 ± 0.4 | — | — | 17.3 ± 0.2 | 18.7 ± 0.3 | |
| — | — | 12.7 ± 0.4 | 5.1 ± 0.2 | 25.3 ± 0.2 | — | — | 26.5 ± 0.3 | 28.7 ± 0.3 | |

IPC: image(s) per class. Ratio (%): the ratio of distilled images to the whole training set. The works DD^{†} and LD^{†} use AlexNet for CIFAR-10 dataset. All other methods use a 128-width ConvNet for training and evaluation. Bold entries are the best results.
Note:
some entries are marked as absent due to scalability issues or unreported values. For more information, refer to the supplementary materials. [symbol]
indicates data missing or illegible when filed

TABLE 2
The performance (testing accuracy %) comparison to state-of-the-
art methods on ImageNet-1K [14] and ImageNet subsets.

| | IPC | Ratio % | Resolution | Random | DM [ [symbol] ] | DataDAM | Whole Dataset |
|---|---|---|---|---|---|---|---|
| ImageNet-1K | 1 | 0.078 | 64 | 0.5 ± 0.1 | 1.3 ± 0.1 | 2.0 ± 0.1 | 33.8 ± 0.3 |
| | 2 | 0.156 | 64 | 0.9 ± 0.1 | 1.6 ± 0.1 | 2.2 ± 0.1 | |
| | 10 | 0.780 | 64 | 3.1 ± 0.2 | 5.7 ± 0.1 | 6.3 ± 0.0 | |
| | 50 | 3.902 | 64 | 7.6 ± 1.2 | 11.4 ± 0.9 | 15.5 ± 0.2 | |
| ImageNette | 1 | 0.105 | 128 | 23.5 ± 4.8 | 32.8 ± 0.5 | 34.7 ± 0.9 | 87.4 ± 1.0 |
| | 10 | 1.050 | 128 | 47.7 ± 2.4 | 58.1 ± 0.3 | 59.4 ± 0.4 | |
| ImageWoof | 1 | 0.110 | 128 | 14.2 ± 0.9 | 21.1 ± 1.2 | 24.2 ± 0.5 | 67.0 ± 1.3 |
| | 10 | 1.100 | 128 | 27.0 ± 1.9 | 31.4 ± 0.5 | 34.4 ± 0.4 | |
| ImageSquawk | 1 | 0.077 | 128 | 21.8 ± 0.5 | 31.2 ± 0.7 | 36.4 ± 0.8 | 87.5 ± 0.3 |
| | 10 | 0.770 | 128 | 40.2 ± 0.4 | 50.4 ± 1.2 | 55.4 ± 0.9 | |

[symbol]

indicates data missing or illegible when filed

Cross-architecture Generalization: Learned synthetic data created using an implementation of the present disclosure has been tested across different unseen neural architectures, consistent with benchmarks.

To that end, synthetic data was generated from CIFAR10 using one architecture (T) with IPC50 and then transferred to a new architecture (E), where it was trained from scratch and tested on real-world data. Popular CNN architectures like ConvNet, AlexNet, VGG-11, and ResNet-18 are used to examine the generalization performance. Table 3 shows that DataDAM outperforms state-of-the-art across unseen architectures when the synthetic data is learned with ConvNet.

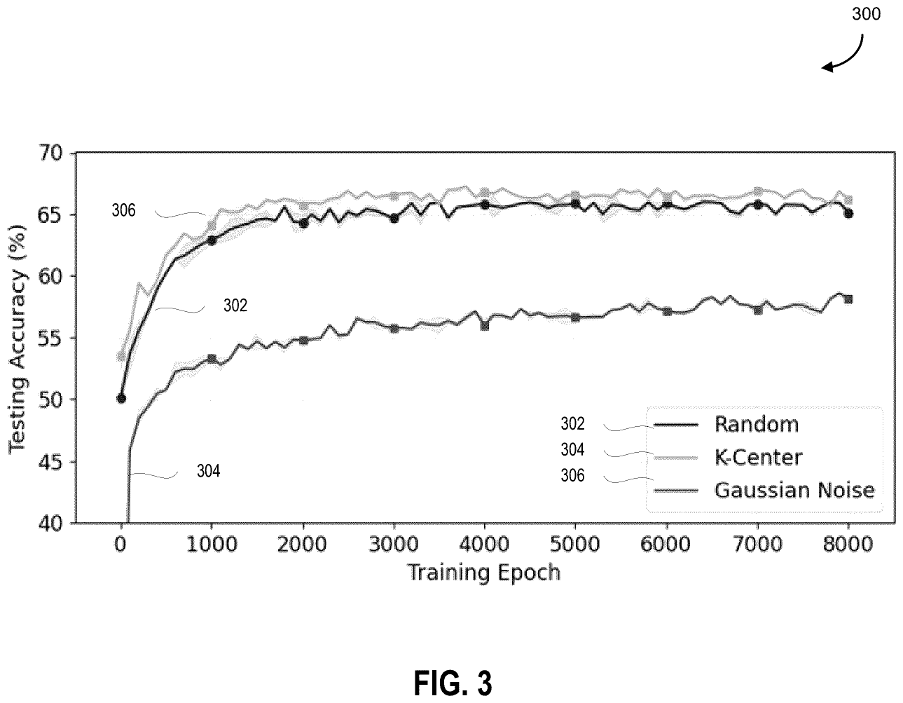

A margin of 3.8% and 7.4% is achieved when transferring to AlexNet and VGG-11, respectively, surpassing the best method, DM. Additionally, the remaining architectures demonstrate improvement due to the robustness of the disclosed method's synthetic images and their reduced architectural bias, as seen in the natural appearance of the distilled images in FIG. 3.

TABLE 3
Cross-architecture testing performance (%) on CIFAR10 with 50 images
per class. The synthetic set is trained on one architecture (T) and then evaluated on another
architecture (E).

| | TE | ConvNet | AlexNet | VGG-11 | ResNet-18 |
|---|---|---|---|---|---|
| DC [64] | ConvNet | 53.9 ± 0.5 | 28.8 ± 0.7 | 38.8 ± 1.1 | 20.9 ± 1.0 |
| CAFE [32] | ConvNet | 62.3 ± 0.4 | 43.2 ± 0.4 | 48.8 ± 0.5 | 43.3 ± 0.7 |
| DSA [62] | ConvNet | 60.6 ± 0.5 | 53.7 ± 0.6 | 51.4 ± 1.0 | 47.8 ± 0.9 |
| DM [63] | ConvNet | 63.0 ± 0.4 | 60.1 ± 0.5 | 57.4 ± 0.8 | 52.9 ± 0.4 |
| KIP [38] | ConvNet | 56.9 ± 0.4 | 53.2 ± 1.6 | 53.2 ± 0.5 | 47.6 ± 0.8 |
| MTT [9] | ConvNet | 66.2 ± 0.6 | 43.9 ± 0.9 | 48.7 ± 1.3 | 60.0 ± 0.7 |
| DataDAM | ConvNet | 67.0 ± 0.4 | 63.9 ± 0.9 | 64.8 ± 0.5 | 60.2 ± 0.7 |
| | AlexNet | 61.8 ± 0.6 | 60.6 ± 0.9 | 61.8 ± 0.6 | 56.4 ± 0.7 |
| | VGG-11 | 56.5 ± 0.4 | 53.7 ± 1.5 | 56.2 ± 0.6 | 52.0 ± 0.7 |

Training Cost Analysis: The described method is compared to state-of-the-art benchmarks presented in Table 4. The described method demonstrates a significantly lower run-time by almost two orders of magnitude compared to most state-of-the-art results.

This method, like DM, has an advantage over methods such as DC, DSA, and MTT that require costly inner-loop bi-level optimization.

It should be noted that DataDAM can leverage information from randomly initialized neural networks without training and consistently achieve superior performance.

TABLE 4
Training time and GPU memory comparisons for state-of-the-art synthesis
methods. Run time is expressed per step, averaged over 100 iterations. GPU memory is
expressed as the peak memory usage during 100 iterations of training. All methods were run
on an A100 GPU for CIFAR-10. OOM (out-of-memory) is reported for methods that are unable
to run within the GPU memory limit.

| | run time (sec) | | | GPU memory (MB) | | |
|---|---|---|---|---|---|---|
| Method | IPC1 | IPC10 | IPC50 | IPC1 | IPC10 | IPC50 |
| DC [64] | 0.16 ± 0.01 | 3.31 ± 0.02 | 15.74 ± 0.10 | 3515 | 3621 | 4527 |
| DSA [62] | 0.22 ± 0.02 | 4.47 ± 0.12 | 20.13 ± 0.58 | 3513 | 3639 | 4539 |
| DM [63] | 0.08 ± 0.02 | 0.08 ± 0.02 | 0.08 ± 0.02 | 3323 | 3455 | 3605 |
| MTT [9] | 0.36 ± 0.23 | 0.40 ± 0.20 | OOM | 2711 | 8049 | OOM |
| DataDAM | 0.09 ± 0.01 | 0.08 ± 0.01 | 0.16 ± 0.04 | 3452 | 3561 | 3724 |

Ablation Studies: The robustness of the described method was evaluated with ablation studies under different experimental configurations. All experiments averaged performance over 100 randomly initialized ConvNets across five synthetic sets. The CIFAR10 dataset is used for all studies. The most relevant ablation studies to the described method are included here; further ablative experiments are included in the supplementary materials.

Exploring the importance of different initialization methods for synthetic images. In dataset distillation, synthetic images are usually initialized through Gaussian noise or sampled from the real data; however, the choice of initialization method has proved to be crucial to the overall performance.

To assess the robustness of DataDAM, an empirical evaluation with an IPC50 was conducted under three initialization conditions: Random selection 302, K-Center 304, and Gaussian noise 306 (FIG. 3). As reported in, other works including have seen benefits to testing performance and convergence speed by leveraging K-Center as a smart selection. Empirically, the described method is shown to be robust across both random and K-Center with only a minute performance gap, and thus the initialization of synthetic data is not as crucial to this method's final performance. Finally, when comparing with noise, a performance reduction is noticeable; however, based on the progression over the training epochs, it appears the described method is successful in transferring the information from the real data onto the synthetic images.

FIG. 3 is a graph that shows test accuracy evolution of synthetic image learning on CIFAR10 with IPC50 under three different initializations: Random, K-Center, and Gaussian noise, according to some embodiments.

Evaluation of task balance A in DataDAM: Regularization can be used to prevent overfitting and improve generalization. In the case of DataDAM, the regularizing coefficient A controls the tradeoff between the attention matching loss LSAM and the maximum mean discrepancy loss EMMD, which aims to reduce the discrepancy between the synthetic and real training distributions.

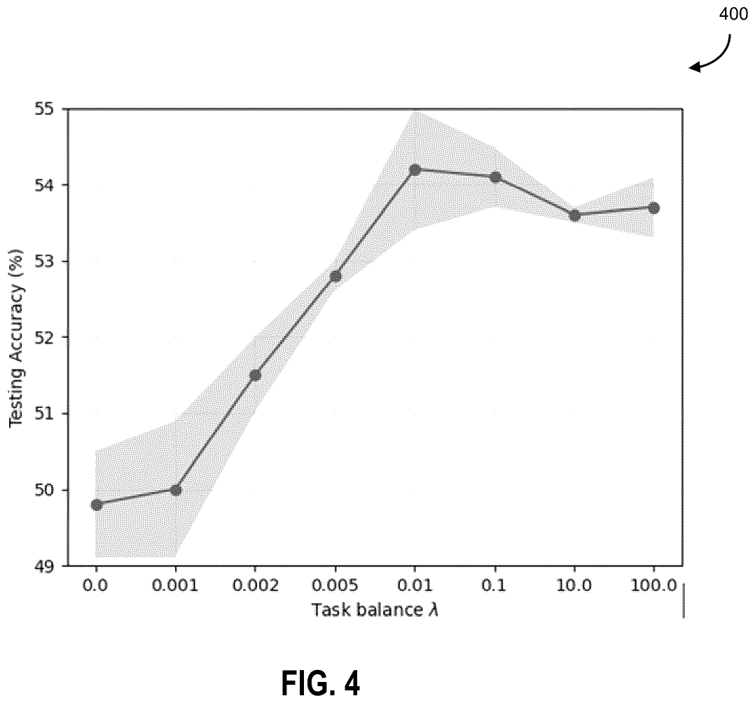

The experiments conducted on the CIFAR10 dataset with IPC 10 showed that increasing the value of A improved the performance of DataDAM up to a certain point (FIG. 4). This is because, at lower values of A, the attention matching loss dominates the training process, while at higher values of A, the regularizer contributes more effectively to the overall performance. The results shown in the graph 400 in FIG. 4 also indicate that the method is robust to larger regularization terms, as shown by the plateau to the right of 0.01. Therefore, a task balance of 0.01 is chosen for all experiments on low-resolution data and 0.02 on medium- and high-resolution data. FIG. 4 is a graph that shows the effect of task balance A on the testing accuracy (%) for CIFAR10 dataset with IPC10 configuration, according to some embodiments.

Evaluation of loss components in DataDAM: An ablation study was conducted to evaluate the contribution of each loss component, namely spatial attention matching loss ( [symbol] ) and the complementary loss ( [symbol] ), to the final performance of DataDAM. As seen in Table 5, the joint use of [symbol] and [symbol] led to state-of-the-art results, while using [symbol] alone resulted in significant underperformance, as it emphasizes the extraction of high-level abstract data but fails to capture different level representations of the real training distribution. On the other hand, [symbol] alone outperformed the base complementary loss, indicating the extracted discriminative features contain significant information about the training but still have room for improvement. To highlight the importance of intermediate representations, the described attention-based transfer approach was compared with the transfer of layer-wise feature maps, similar to CAFE, and demonstrated a significant performance gap (see “Feature Map Transfer” in Table 5).

Overall, these findings support the use of attention to match layer-wise representations and a complementary loss to regulate the process.

TABLE 5
Evaluation of loss components in DataDAM.

| [symbol] MMD | [symbol] SAM | Feature Map Transfer 1 | Testing Performance (9%) |
|---|---|---|---|
| ✓ | — | — | 48.9 ± 0.6 |
| — | ✓ | — | 49.8 ± 0.7 |
| — | — | ✓ | 47.2 ± 0.3 |
| ✓ | ✓ | — | 54.2 ± 0.8 |

Exploring the effect of each layer in DataDAM: As shown in Table 6, different layers in DataDAM perform differently since each provides different levels of information about the data distributions. This finding supports the claim that matching spatial attention maps in individual layers alone cannot obtain promising results. As a result, to improve the overall performance of the synthetic data learning process, it is crucial to transfer different levels of information about the real data distribution using the SAM module across all intermediate layers.

TABLE 6
Evaluation of each layer's impact in ConvNet (3-layer). The output is
transferred under LMMD while the effects of the specified layers are measured through [symbol] .
The performance of the CIFAR10 dataset with IPC10 was evaluated.

| Layer 1 | Layer 2 | Last Layer | Testing Performance (%) |
|---|---|---|---|
| — | — | ✓ | 48.9 ± 0.6 |
| ✓ | — | ✓ | 50.2 ± 0.4 |
| — | ✓ | ✓ | 51.5 ± 1.0 |
| ✓ | ✓ | — | 49.8 ± 0.7 |
| ✓ | ✓ | ✓ | 54.2 ± 0.8 |

Network Distributions: The impact of network initialization on DataDAM's performance was investigated by training 1000. ConvNet architectures with random initializations on the original training data and categorizing their learned states into five buckets based on testing performance. Networks from each bucket were sampled and the synthetic data was trained using IPCs 1, 10, and 50.

As illustrated in Table 7, findings indicate that DataDAM is robust across various network initializations. This is attributed to the transfer of attention maps that contain relevant and discriminative information rather than the entire feature map statistics. These results reinforce the idea that achieving state-of-the-art performance does not require inner-loop model training.

TABLE 7
Performance of synthetic data learned with IPCs 1, 10, and 50 for different
network initialization. Models are trained on the training set and grouped by their respective
accuracy levels.

| IPC | Random | 0-20 | 20-40 | 40-60 | 60-80 | ≥80 |
|---|---|---|---|---|---|---|
| 1 | 32.0 ± 2.0 | 30.8 ± 1.1 | 30.7 ± 1.7 | 31.5 ± 1.9 | 26.2 ± 1.8 | 26.9 ± 1.3 |
| 10 | 54.2 ± 0.8 | 54.0 ± 0.7 | 53.1 ± 0.5 | 52.1 ± 0.8 | 51.2 ± 0.7 | 51.7 ± 0.7 |
| 50 | 67.0 ± 0.4 | 66.2 ± 0.4 | 66.4 ± 0.4 | 67.0 ± 0.5 | 65.8 ± 0.5 | 65.3 ± 0.6 |

### Visualization

Data Distribution: To evaluate whether embodiments of the proposed approach and method can capture a more accurate distribution from the original dataset, t-SNE was used to visualize the features of real and synthetic sets generated by DM, DSA, CAFE, and DataDAM in the embedding space of the ResNet-18 architecture.

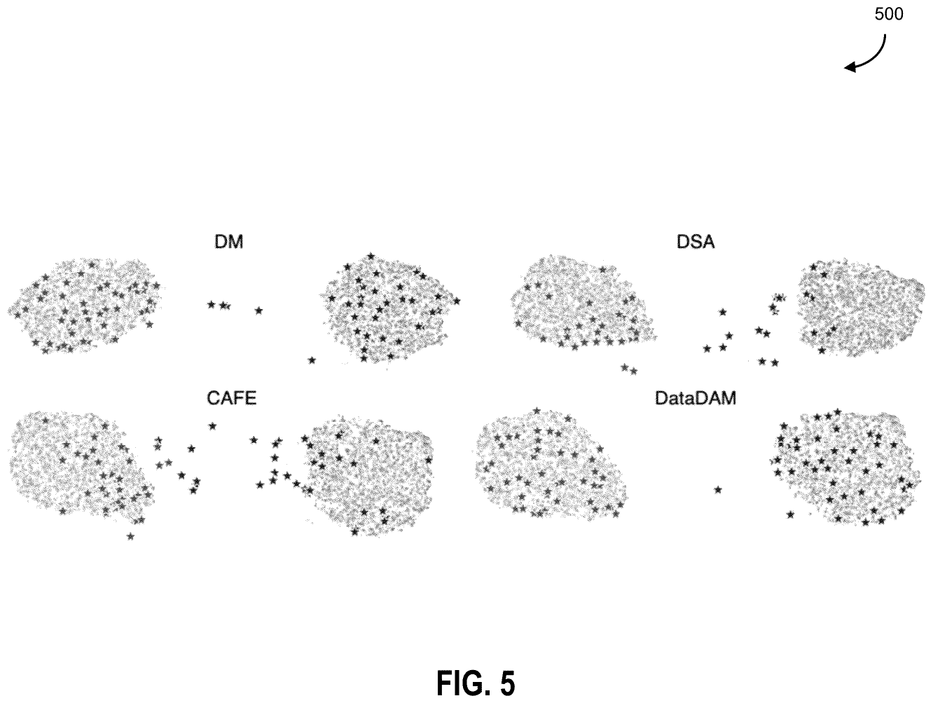

FIG. 5 shows a set of distributions 500 indicating that methods such as DSA and CAFE are biased towards the edges of their clusters and not representative of the training data. FIG. 5 is a rendering showing of distributions of synthetic images learned by four methods on CIFAR10 with IPC50. The stars represent the synthetic data dispersed amongst the original training dataset.

Much like DM, these results indicate a more equalized distribution, allowing better capture of the data distribution. Preserving dataset distributions is of utmost importance in fields like ethical machine learning since methods that cannot be impartial in capturing data distribution can lead to bias and discrimination. The described method's capacity to capture the distribution of data makes it more appropriate than other approaches in these conditions, particularly in fields such as facial detection for privacy.

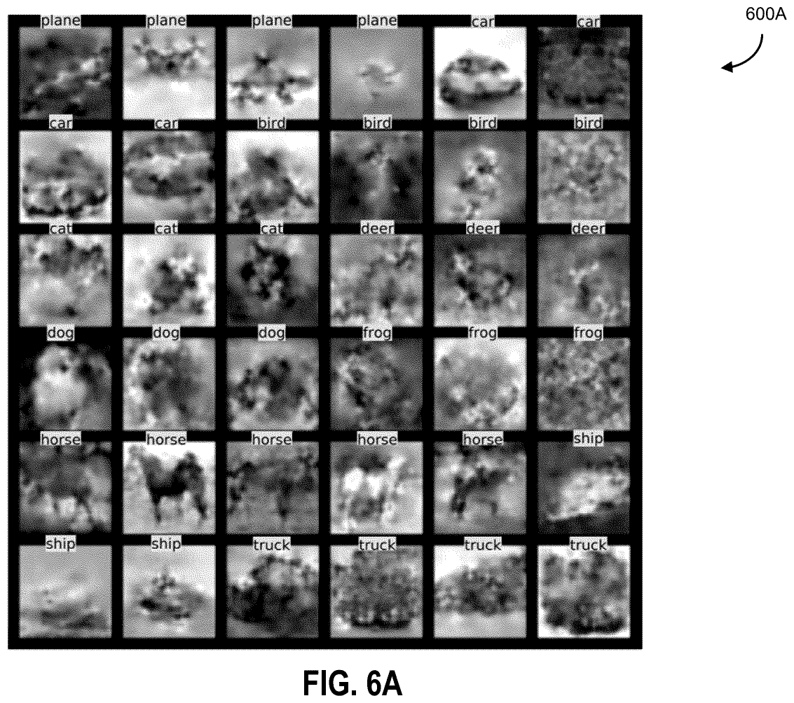

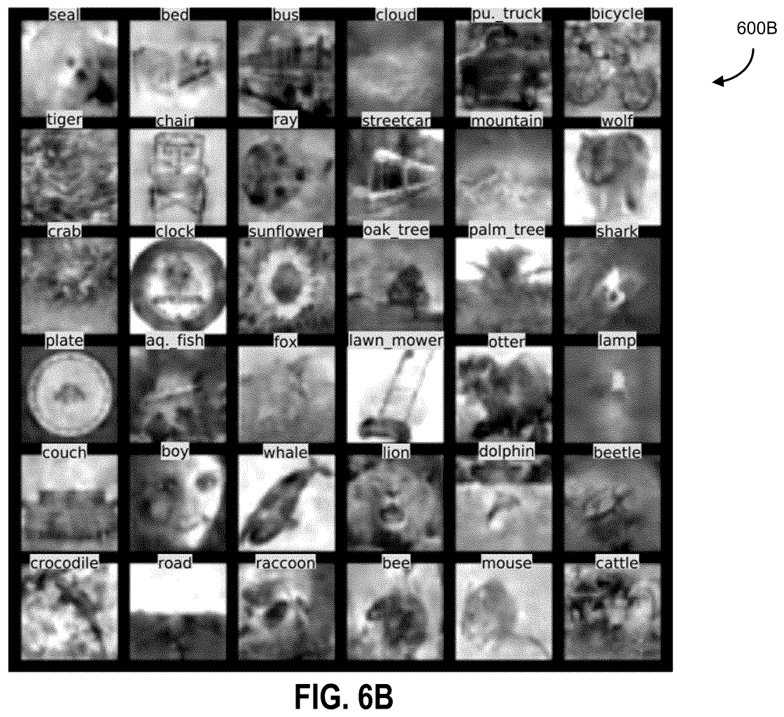

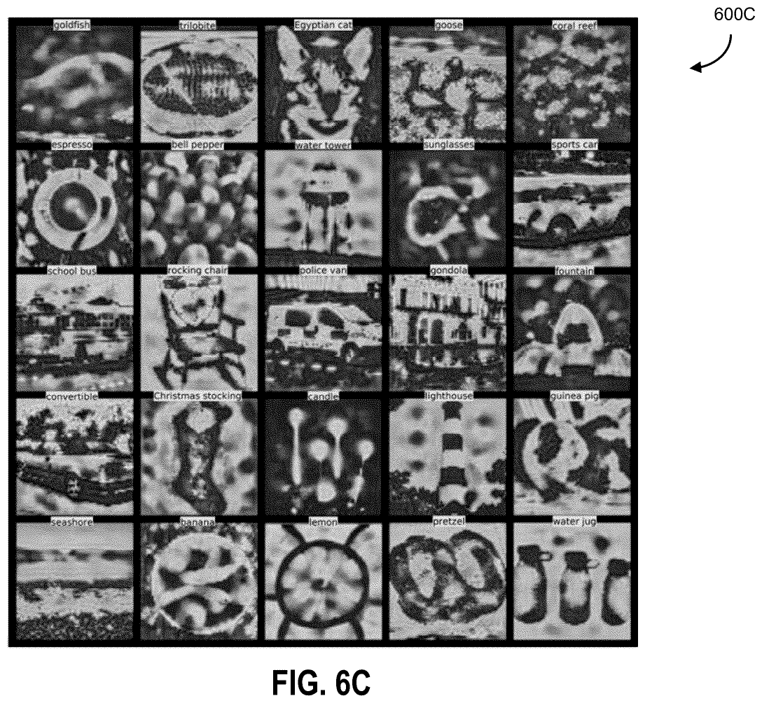

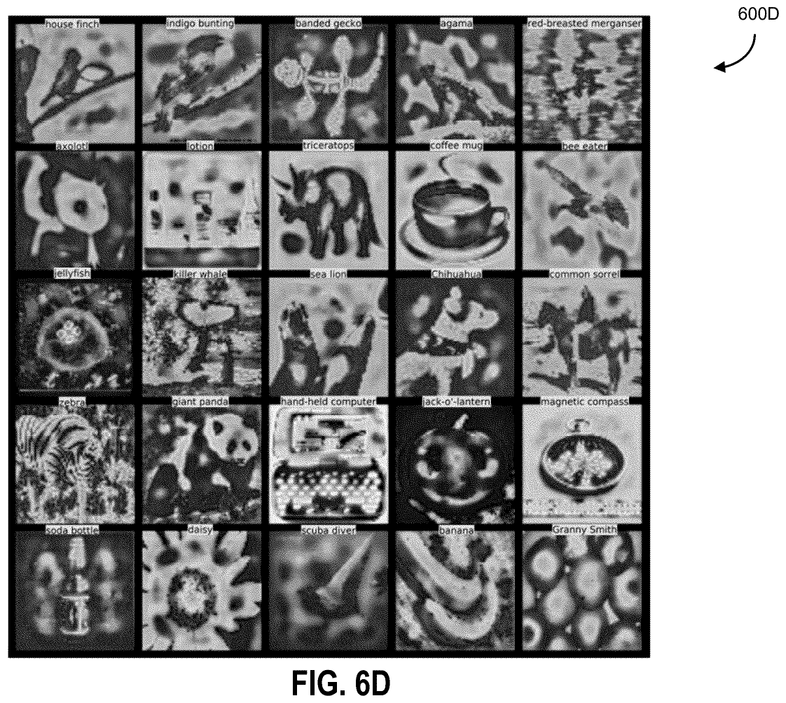

Synthetic Images: Samples from the described method's learned synthetic images for different resolutions are included in FIG. 6A-6D. FIG. 6A-6D shows example distilled images 600A, 600B, 600C, and 600D from 32×32 CIFAR10/100 (IPC10), 64×64 Tiny ImageNet (IPC1), and 64×64 ImageNet-1K (IPC1).

In low-resolution images, the objects are easily distinguishable, and their class labels can be recognized intuitively. Moving to higher-resolution images, the objects become more outlined and distinct from their backgrounds. These synthetic images have a natural look and can be transferred well to different architectures. Moreover, the high-resolution images accurately represent the relevant colors of the objects and provide more meaningful data for downstream tasks.

Applications: The effectiveness of DataDAM's performance is assessed through the use of two prevalent applications involving dataset distillation approaches: continual learning and neural architecture search.

Continual Learning: Continual learning trains a model incrementally with new task labels to prevent catastrophic forgetting. One approach is to maintain a replay buffer that stores balanced training examples in memory and train the model exclusively on the latest memory, starting from scratch.

Efficient storage of exemplars is crucial for optimal continual learning performance, and condensed data can play a significant role. The class-incremental setting from with an augmented buffer size of 20 IPC is used to conduct class-incremental learning on the CIFAR100 dataset. The proposed memory construction approach is compared with random, herding, DSA, and DM methods at 5 and 10 learning steps. In each step, including the initial one, 400 and 200 distilled images were added to the replay buffer, respectively, following the class split of [63]. The test accuracy is the performance metric, and default data preprocessing and ConvNet are used for each approach.

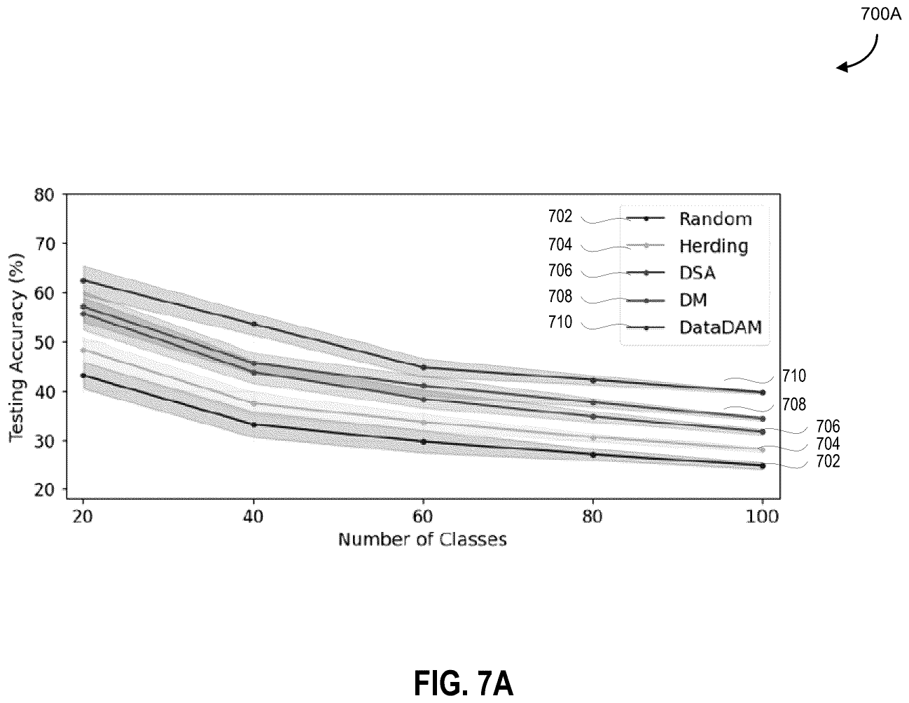

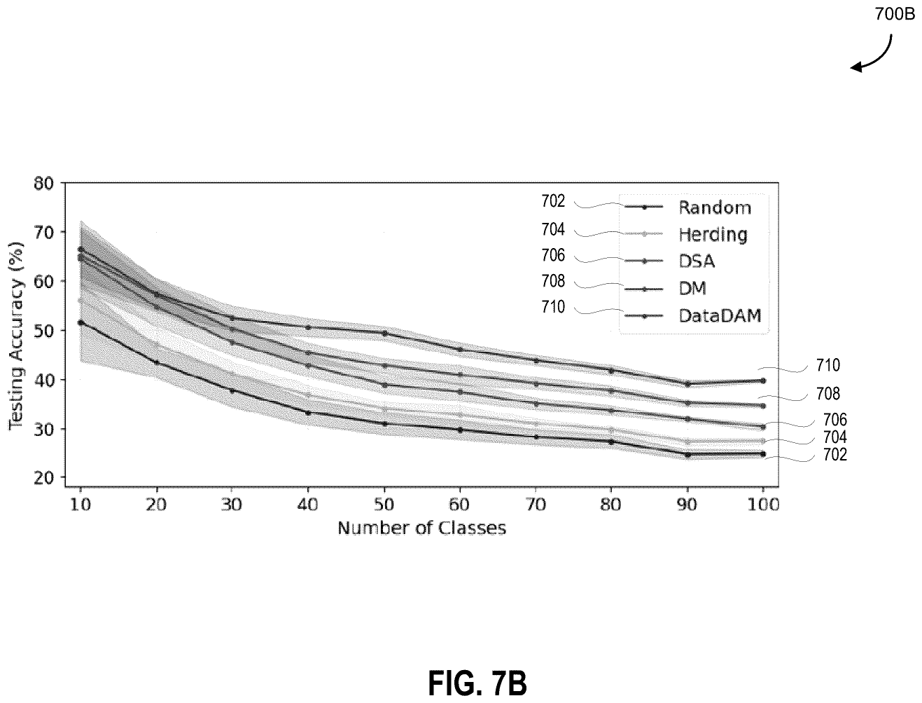

FIG. 7A and FIG. 7B shows that the memory construction approach proposed herein consistently outperforms others in both settings. FIG. 7A illustrates a 5-step setting and FIG. 7B illustrates a 10-step continual learning setting with tolerance region.

Specifically, DataDAM achieves final test accuracies of 39.7% and 39.7% in 5-step and 10-step learning, respectively, outperforming DM (34.4% and 34.7%), DSA (31.7% and 30.3%), herding (28.1% and 27.4%), and random (24.8% and 24.8%).

Notably, the final performance of DataDAM, DM, and random selection methods remains unchanged upon increasing the number of learning steps, as these methods independently learn the synthetic datasets for each class. These findings reveal that DataDAM provides more informative training to the models than other baselines, resulting in more effective prevention of memory loss associated with past tasks.

Neural Architecture Search: The described method's synthetic sets can be used as a proxy set to accelerate model evaluation in Neural Architecture Search (NAS).

Following [64], a 720 ConvNet search space was established on CIFAR10 with a grid varying in network depth, width, activation, normalization, and pooling layers. The described method was compared with Random, DSA, CAFE, early stopping, and DM. Each architecture was trained on the proxy set (synthetic 50 IPC) for 200 epochs and the whole dataset for 100 epochs to establish a baseline performance metric. Early stopping still uses the entire dataset, but the iterations are limited to those of the proxy set, as in [63].

For each method, all the architectures are ranked based on the validation performance and report the testing accuracy of the best-selected model when trained on the whole dataset in Table 8.

DataDAM achieved the best accuracy among the competitors, with an accuracy of 89.0%, which is very similar to the original training data at 89.2%, indicating the potential of the produced proxy set to accurately represent the training data. Furthermore, Spearman's correlation was calculated over the entire search space to evaluate the robustness of the learned data in architecture searching. The correlation is calculated between the testing performances of each method when trained on the proxy versus the original training data. The described method achieves the highest correlation (0.72), indicating that it generates a suitable proxy set that is generalizable across the entire search space and encodes the most important and relevant information from the training data into a condensed form.

TABLE 8
Neural architecture search on CIFAR10.

| | | | | | | Early- | Whole |
|---|---|---|---|---|---|---|---|
| | Random | DSA | DM | CAFE | Ours | stopping | Dataset |
| Performance (%) | 88.9 | 87.2 | 87.2 | 83.6 | 89.0 | 88.9 | 89.2 |
| Correlation | 0.70 | 0.66 | 0.71 | 0.59 | 0.72 | 0.69 | 1.00 |
| Time cost (min) | 206.4 | 206.4 | 206.6 | 206.4 | 206.4 | 206.2 | 5168.9 |
| Storage (imgs) | 500 | 500 | 500 | 500 | 500 | 5 × 10⁴ | 5 × 10⁴ |

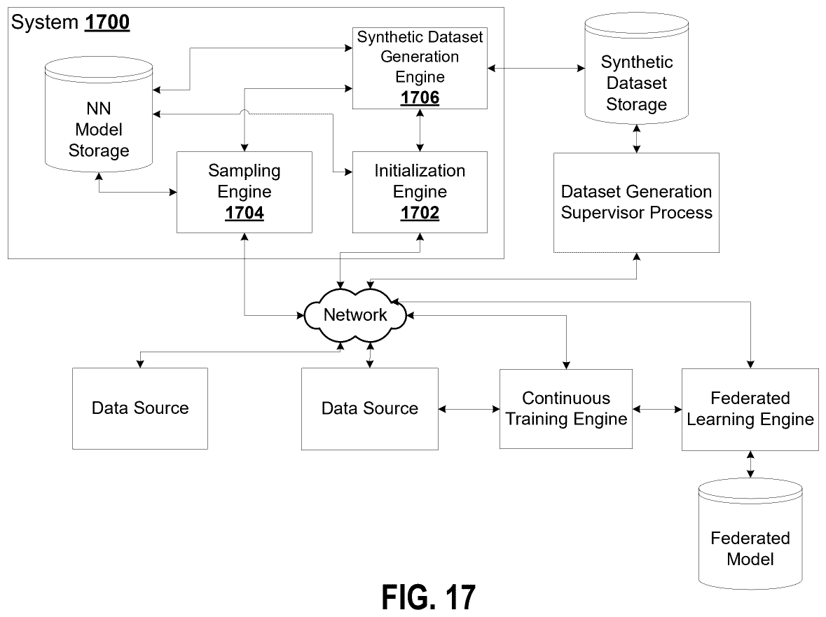

FIG. 17 is a computer block schematic diagram showing an example computer system configured for distilling a first input dataset to generate a condensed synthetic dataset.

The computer system 1700 can include a computer processor operating in conjunction with computer memory and a non-transitory computer readable data storage. The computer system can be configured for interoperation with upstream and downstream computing systems, where it receives the first input dataset and outputs the condensed synthetic dataset for downstream machine consumption.

An initialization engine 1702 is configured to initialize the learnable synthetic dataset with synthetic image and label pairs, and then instantiate a plurality of randomly initialized deep neural networks having L layers configured to embed both the first input dataset and the learnable synthetic dataset. The randomly initialized deep neural networks can be maintained on the non-transitory computer readable data storage as corresponding sets of parameters.

A sampling engine 1704 then, for each class present in the first input dataset, samples a batch of real and synthetic data from the first input dataset and the learnable synthetic dataset and generate a first feature map for the first input dataset and a second feature map for the learnable synthetic dataset, each feature map having feature arrays corresponding to each layer of the L layers, and generates a pair of attention maps using a feature-based mapping function that takes feature arrays of a plurality of layers of the L layers as an input, the pair of attention maps including a first attention map for the first input dataset and a second attention map for the learnable synthetic dataset.

A synthetic dataset generation engine 1706 then iteratively updates the learnable synthetic dataset to learn condensed synthetic dataset the based at least on a comparison of the pair of attention maps using a loss function to approximate a distribution of the first input dataset and generates the condensed synthetic dataset as a output data object.

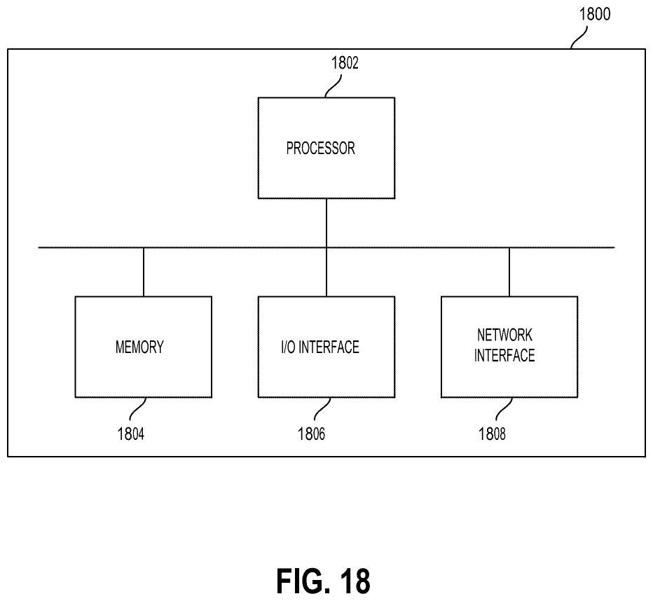

FIG. 18 is a block schematic of an example computer system, according to some embodiments. The computer 1800 is configured for generating condensed synthetic sets using a dataset distillation with attention matching (DataDAM) approach that matches spatial attention maps of real and synthetic data generated by different layers within a family of randomly initialized neural networks as described herein. The computer 1800 includes a computer processor 1802 which executes instruction sets that are stored in memory 1804 to execute steps of a computing method. The instruction sets can be stored on data storage. The computer 1800 can couple to upstream or downstream computer servers through network interface 1808, and can receive input/output commands through input devices and/or pins (GPIO pins).

Applicants conducted testing across reference datasets and found a measurable improvement. The system can also be provided in the form of corresponding computer program products (non-transitory computer readable media having computer instructions stored thereon).

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

### REFERENCES

[1] Hossam Amer, Ahmed H Salamah, Ahmad Sajedi, and Enhui Yang. High performance convolution using sparsity and patterns for inference in deep convolutional neural networks. arXiv preprint arXiv: 2104.08314, 2021. 1
[2] Dzmitry Bahdanau, Kyung Hyun Cho, and Yoshua Bengio. Neural machine translation by jointly learning to align and translate. In 3rd International Conference on Learning Representations, 2015. 3
[3] Jihwan Bang, Heesu Kim, YoungJoon Yoo, Jung-Woo Ha, and Jonghyun Choi. Rainbow memory: Continual learning with a memory of diverse samples. In Proceedings of the IEEE/CVF Conference on Computer Vision and Pattern Recognition, pages 8218-8227, 2021. 8
[4] Eden Belouadah and Adrian Popescu. Scail: Classifier weights scaling for class incremental learning. In Proceedings of the IEEE/CVF winter conference on applications of computer vision, pages 1266-1275, 2020. 1, 2, 5, 8
[5] Ondrej Bohdal, Yongxin Yang, and Timothy Hospedales. Flexible dataset distillation: Learn labels instead of images. arXiv preprint arXiv: 2006.08572, 2020. 2, 5
[6] Andrew Brock, Jeff Donahue, and Karen Simonyan. Large scale gan training for high fidelity natural image synthesis. In International Conference on Learning Representations, 2019. 6, 13
[7] Weipeng Cao, Xizhao Wang, Zhong Ming, and Jinzhu Gao. A review on neural networks with random weights. Neurocomputing, 275:278-287, 2018. 2
[8] Francisco M Castro, Manuel J Mar′ n-Jimenez, Nicol′ as Guil,′ Cordelia Schmid, and Karteek Alahari. End-to-end incremental learning. In Proceedings of the European conference on computer vision (ECCV), pages 233-248, 2018. 1, 2, 5, 8
[9] George Cazenavette, Tongzhou Wang, Antonio Torralba, Alexei A Efros, and Jun-Yan Zhu. Dataset distillation by matching training trajectories. In Proceedings of the IEEE/CVF Conference on Computer Vision and Pattern Recognition, pages 4750-4759, 2022. 2, 5, 6, 12, 13, 15
[10] Umur A Ciftci, Gokturk Yuksek, and Ilke Demir. My face my choice: Privacy enhancing deepfakes for social media anonymization. In Proceedings of the IEEE/CVF Winter Conference on Applications of Computer Vision, pages 1369-1379, 2023. 8
[11] Ekin D Cubuk, Barret Zoph, Dandelion Mane, Vijay Vasudevan, and Quoc V Le. Autoaugment: Learning augmentation policies from data. arXiv preprint arXiv: 1805.09501, 2018. 14
[12] Ekin D Cubuk, Barret Zoph, Jonathon Shlens, and Quoc V Le. Randaugment: Practical automated data augmentation with a reduced search space. In Proceedings of the IEEE/CVF conference on computer vision and pattern recognition workshops, pages 702-703, 2020. 14
[13] Justin Cui, Ruochen Wang, Si Si, and Cho-Jui Hsieh. Dcbench: Dataset condensation benchmark. In Thirty-sixth Conference on Neural Information Processing Systems Datasets and Benchmarks Track. 2, 3, 7, 14, 16, 18, 19
[14] Jia Deng, Wei Dong, Richard Socher, Li-Jia Li, Kai Li, and Li Fei-Fei. Imagenet: A large-scale hierarchical image database. In 2009 IEEE conference on computer vision and pattern recognition, pages 248-255. leee, 2009. 1, 2, 5, 12
[15] Tian Dong, Bo Zhao, and Lingjuan Lyu. Privacy for free: How does dataset condensation help privacy? In International Conference on Machine Learning, pages 5378-5396. PMLR, 2022. 2
[16] Xuanyi Dong and Yi Yang. Nas-bench-201: Extending the scope of reproducible neural architecture search. In International Conference on Learning Representations, 2020. 16
[17] Alexey Dosovitskiy, Lucas Beyer, Alexander Kolesnikov, Dirk Weissenborn, Xiaohua Zhai, Thomas Unterthiner, Mostafa Dehghani, Matthias Minderer, Georg Heigold, Sylvain Gelly, et al. An image is worth 16×16 words: Transformers for image recognition at scale. In International Conference on Learning Representations, 2021. 1
[18] Spyros Gidaris and Nikos Komodakis. Dynamic few-shot visual learning without forgetting. In Proceedings of the IEEE conference on computer vision and pattern recognition, pages 4367-4375, 2018. 5, 6, 13, 18
[19] Raja Giryes, Guillermo Sapiro, and Alex M Bronstein. Deep neural networks with random gaussian weights: A universal classification strategy? IEEE Transactions on Signal Processing, 64 (13): 3444-3457, 2016. 2
[20] Ian Goodfellow, Jean Pouget-Abadie, Mehdi Mirza, Bing Xu, David Warde-Farley, Sherjil Ozair, Aaron Courville, and Yoshua Bengio. Generative adversarial networks. Communications of the ACM, 63 (11): 139-144, 2020. 13
[21] Arthur Gretton, Karsten M Borgwardt, Malte J Rasch, Bernhard Scholkopf, and Alexander Smola. A kernel two-sample “test. The Journal of Machine Learning Research, 13 (1): 723-773, 2012. 4, 13
[22] Kaiming He, Xiangyu Zhang, Shaoqing Ren, and Jian Sun. Delving deep into rectifiers: Surpassing human-level performance on imagenet classification. In ICCV, 2015. 3, 5
[23] Kaiming He, Xiangyu Zhang, Shaoqing Ren, and Jian Sun. Deep residual learning for image recognition. In Proceedings of the IEEE conference on computer vision and pattern recognition, pages 770-778, 2016. 1, 6, 18
[24] Geoffrey Hinton, Oriol Vinyals, and Jeff Dean. Distilling the knowledge in a neural network. arXiv preprint arXiv: 1503.02531, 2015. 1
[25] J Howard. Imagenette: A smaller subset of 10 easily classified classes from imagenet, and a little more french, 2019. 12, 13
[26] Jacob Devlin Ming-Wei Chang Kenton and Lee Kristina Toutanova. Bert: Pre-training of deep bidirectional transformers for language understanding. In Proceedings of NAACLHLT, pages 4171-4186, 2019. 1
[27] Samir Khaki and Weihan Luo. Cfdp: Common frequency domain pruning. In Proceedings of the IEEE/CVF Conference on Computer Vision and Pattern Recognition (CVPR) Workshops, pages 4714-4723 June 2023. 1
[28] Diederik P Kingma and Max Welling. Auto-encoding variational bayes. arXiv preprint arXiv: 1312.6114, 2013. 13
[29] Alex Krizhevsky, Geoffrey Hinton, et al. Learning multiple layers of features from tiny images. 2009. 5, 12
[30] Alex Krizhevsky, Ilya Sutskever, and Geoffrey E Hinton. Imagenet classification with deep convolutional neural networks. Communications of the ACM, 60(6): 84-90, 2017. 5, 6, 18
[31] Ya Le and Xuan Yang. Tiny imagenet visual recognition challenge. CS 231N, 7(7): 3, 2015. 5, 12
[32] Jaehoon Lee, Lechao Xiao, Samuel Schoenholz, Yasaman Bahri, Roman Novak, Jascha Sohl-Dickstein, and Jeffrey Pennington. Wide neural networks of any depth evolve as linear models under gradient descent. Advances in neural information processing systems, 32, 2019. 2
[33] Saehyung Lee, Sanghyuk Chun, Sangwon Jung, Sangdoo Yun, and Sungroh Yoon. Dataset condensation with contrastive signals. In International Conference on Machine Learning, pages 12352-12364. PMLR, 2022. 2
[34] Yujia Li, Kevin Swersky, and Rich Zemel. Generative moment matching networks. In International conference on machine learning, pages 1718-1727. PMLR, 2015. 6, 13
[35] Chao Ma, Jia-Bin Huang, Xiaokang Yang, and Ming-Hsuan Yang. Hierarchical convolutional features for visual tracking. In Proceedings of the IEEE international conference on computer vision, pages 3074-3082, 2015. 4
[36] Mehdi Mirza and Simon Osindero. Conditional generative adversarial nets. arXiv preprint arXiv: 1411.1784, 2014. 13
[37] Timothy Nguyen, Zhourong Chen, and Jaehoon Lee. Dataset meta-learning from kernel-ridge regression. In International Conference on Learning Representations, 2021. 2, 6, 12, 14
[38] Timothy Nguyen, Roman Novak, Lechao Xiao, and Jaehoon Lee. Dataset distillation with infinitely wide convolutional networks. Advances in Neural Information Processing Systems, 34:5186-5198, 2021. 2, 5, 6, 12
[39] Gaurav Parmar, Dacheng Li, Kwonjoon Lee, and Zhuowen Tu. Dual contradistinctive generative autoencoder. In Proceedings of the IEEE/CVF Conference on Computer Vision and Pattern Recognition, pages 823-832, 2021. 6, 13
[40] Ameya Prabhu, Philip H S Torr, and Puneet K Dokania. Gdumb: A simple approach that questions the progress in continual learning. In Computer Vision-ECCV 2020: 16th European Conference, Glasgow, UK, Aug. 23-28, 2020, Proceedings, Part II 16, pages 524-540. Springer, 2020. 8
[41] Sylvestre-Alvise Rebuffi, Alexander Kolesnikov, Georg Sperl, and Christoph H Lampert. icarl: Incremental classifier and representation learning. In Proceedings of the IEEE conference on Computer Vision and Pattern Recognition, pages 2001-2010, 2017. 1, 2,5,8
[42] Kuniaki Saito, Kohei Watanabe, Yoshitaka Ushiku, and Tatsuya Harada. Maximum classifier discrepancy for unsupervised domain adaptation. In Proceedings of the IEEE conference on computer vision and pattern recognition, pages 3723-3732, 2018. 4
[43] Ahmad Sajedi, Samir Khaki, Konstantinos N Plataniotis, and Mahdi S Hosseini. End-to-end supervised multilabel contrastive learning. arXiv preprint arXiv: 2307.03967, 2023. 1
[44] Ahmad Sajedi, Yuri A Lawryshyn, and Konstantinos N Plataniotis. Subclass knowledge distillation with known subclass labels. In 2022 IEEE 14th Image, Video, and Multidimensional Signal Processing Workshop (IVMSP), pages 1-5. IEEE, 2022. 1
[45] Andrew M Saxe, Pang Wei Koh, Zhenghao Chen, Maneesh Bhand, Bipin Suresh, and Andrew Y Ng. On random weights and unsupervised feature learning. In Icml, volume 2, page 6, 2011. 2
[46] Ozan Sener and Silvio Savarese. Active learning for convolutional neural networks: A core-set approach. In International Conference on Learning Representations, 2018. 1, 2, 3, 5, 7, 19
[47] Karen Simonyan and Andrew Zisserman. Very deep convolutional networks for large-scale image recognition. arXiv preprint arXiv: 1409.1556, 2014. 6, 18
[48] Felipe Petroski Such, Aditya Rawal, Joel Lehman, Kenneth Stanley, and Jeffrey Clune. Generative teaching networks: Accelerating neural architecture search by learning to generate synthetic training data. In International Conference on Machine Learning, pages 9206-9216. PMLR, 2020. 2
[49] Mariya Toneva, Alessandro Sordoni, Remi Tachet des Combes, Adam Trischler, Yoshua Bengio, and Geoffrey J Gordon. An empirical study of example forgetting during deep neural network learning. In International Conference on Learning Representations, 2019. 1, 2, 5
[50] Nikolaos Tsilivis, Jingtong Su, and Julia Kempe. Can we achieve robustness from data alone? arXiv preprint arXiv: 2207.11727, 2022. 2
[51] Laurens Van der Maaten and Geoffrey Hinton. Visualizing data using t-sne. Journal of machine learning research, 9 (11), 2008. 5, 8, 18
[52] Kai Wang, Bo Zhao, Xiangyu Peng, Zheng Zhu, Shuo Yang, Shuo Wang, Guan Huang, Hakan Bilen, Xinchao Wang, and Yang You. Cafe: Learning to condense dataset by aligning features. In Proceedings of the IEEE/CVF Conference on Computer Vision and Pattern Recognition, pages 12196-12205, 2022. 1, 2, 5, 6, 7, 8, 18
[53] Tongzhou Wang, Jun-Yan Zhu, Antonio Torralba, and Alexei A Efros. Dataset distillation. arXiv preprint arXiv: 1811.10959, 2018. 2, 5
[54] Xiaolong Wang, Ross Girshick, Abhinav Gupta, and Kaiming He. Non-local neural networks. In Proceedings of the IEEE conference on computer vision and pattern recognition, pages 7794-7803, 2018. 3
[55] Yi Ru Wang, Samir Khaki, Weihang Zheng, Mahdi S. Hosseini, and Konstantinos N. Plataniotis. Conetv2: Efficient auto-channel size optimization for cnns. In 2021 20th IEEE International Conference on Machine Learning and Applications (ICMLA), pages 998-1003, 2021. 1
[56] Sanghyun Woo, Jongchan Park, Joon-Young Lee, and In So Kweon. Cbam: Convolutional block attention module. In Proceedings of the European conference on computer vision (ECCV), pages 3-19, 2018. 3
[57] Jiaxiang Wu, Cong Leng, Yuhang Wang, Qinghao Hu, and Jian Cheng. Quantized convolutional neural networks for mobile devices. In Proceedings of the IEEE conference on computer vision and pattern recognition, pages 4820-4828, 2016. 1
[58] Yuanhao Xiong, Ruochen Wang, Minhao Cheng, Felix Yu, and Cho-Jui Hsieh. Feddm: Iterative distribution matching for communication-efficient federated learning. In Workshop on Federated Learning: Recent Advances and New Challenges (in Conjunction with NeurIPS 2022). 2
[59] Xiyu Yu, Tongliang Liu, Xinchao Wang, and Dacheng Tao. On compressing deep models by low rank and sparse decomposition. In Proceedings of the IEEE conference on computer vision and pattern recognition, pages 7370-7379, 2017. 1
[60] Sergey Zagoruyko and Nikos Komodakis. Paying more attention to attention: Improving the performance of convolutional neural networks via attention transfer. arXiv preprint arXiv: 1612.03928, 2016. 3, 4
[61] Matthew D Zeiler and Rob Fergus. Visualizing and understanding convolutional networks. In Computer Vision-ECCV 2014: 13th European Conference, Zurich, Switzerland, Sep. 6-12, 2014, Proceedings, Part I 13, pages 818-833. Springer, 2014. 4
[62] Bo Zhao and Hakan Bilen. Dataset condensation with differentiable siamese augmentation. In International Conference on Machine Learning, pages 12674-12685. PMLR, 2021. 2, 5, 6, 7, 8, 12, 13, 14, 16, 18
[63] Bo Zhao and Hakan Bilen. Dataset condensation with distribution matching. In Proceedings of the IEEE/CVF Winter Conference on Applications of Computer Vision, pages 6514-6523, 2023. 2, 4, 5, 6, 7, 8, 9, 12, 13, 16, 18
[64] Bo Zhao, Konda Reddy Mopuri, and Hakan Bilen. Dataset condensation with gradient matching. In Ninth International Conference on Learning Representations 2021, 2021. 2, 5, 6, 7, 9, 16, 18
[65] Yongchao Zhou, Ehsan Nezhadarya, and Jimmy Ba. Dataset distillation using neural feature regression. In Advances in Neural Information Processing Systems, 2022. 2, 12
[66] Yanlin Zhou, George Pu, Xiyao Ma, Xiaolin Li, and Dapeng Wu. Distilled one-shot federated learning. arXiv preprint arXiv: 2009.07999, 2020. 2

### SUPPLEMENTARY MATERIALS

### Implementation Details

Datasets: Experiments were conducted on the following datasets: CIFAR10/100 [29], TinyImageNet [31], ImageNet-1K [14], and subsets of ImageNet-1K including ImageNette [25], ImageWoof [25], and ImageSquawk [9]. CIFAR10/100 is a standard computer vision dataset consisting of natural images with colored 32×32 pixels. It has 10 coarse-grained labels (CIFAR10) and 100 fine-grained labels (CIFAR100), each with 50,000 training samples and 10,000 tests. The classes of the CIFAR 10 are “Airplane”, “Car”, “Bird”, “Cat”, “Deer”, “Dog”, “Frog”, “Horse”, “Ship”, and “Truck,” which are mutually exclusive. TinyImageNet is a subset of the ImageNet1K dataset with 200 classes.

The dataset contains 100,000 high-resolution training images and 10,000 test examples that are downsized to 64×64. ImageNet-1K is a standard large-scale dataset with 1,000 classes, including 1,281,167 training examples and 50,000 testing images. Following [65, 63], Applicants resize ImageNet-1K images to 64×64 resolution to match TinyImageNet. Compared to CIFAR10/100, TinyImageNet and ImageNet-1K are more challenging because of their diverse classes and higher image resolution. To further extend dataset distillation, the approach takes a step forward by applying the method to even higher-resolution images, specifically 128×128 subsets of ImageNet. In previous dataset distillation research [9], subsets were introduced based on categories and aesthetics, encompassing birds, fruits, and cats.

In this study, Applicants utilize ImageNette (assorted objects), ImageWoof (dog breeds), and ImageSquawk (birds) to provide additional examples of the algorithm's effectiveness. For a detailed enumeration of ImageNet classes in each of the datasets, please refer to Table 9.

Data Processing: Applicants implemented a standardized preprocessing approach for all datasets, following the methodology outlined in [62]. To ensure optimal model performance during both training and evaluation, applicants utilized several popular transformations, including color jittering, cropping, cutout, scaling, and rotation, as differentiable augmentation strategies across all datasets. For the CIFAR10/100 datasets, applicants additionally applied Kornia zero-phase component analysis (ZCA) whitening, using the same setting as [9]. However, applicants refrained from using ZCA preprocessing for the medium- and high-resolution datasets due to the computational expense of the full-size ZCA transformation. As a result, the distilled images for these datasets display checkboard artifacts (see FIGS. 25, 26, 27, 28, and 29). It is worth noting that applicants visualized the distilled images by directly applying the reverse transformation based on the corresponding data preprocessing without any further modifications.

Implementations of Prior Works: To ensure fair comparisons with prior works, publicly available distilled data were obtained for each baseline method and trained models using the experimental setup. The comparison approach utilized the same ConvNet architecture with three, four, or five layers, depending on the image resolutions, and applied the same preprocessing technique across all methods. In cases where the results were comparable or inferior to those reported in the original papers, applicants presented their default numbers directly. Regarding the Kernel Inducing Points (KIP) method [37, 38], applicants made a slight modification by employing a 128-kernel ConvNet instead of the original 1024-kernel version. To ensure fairness in accordance with the Matching Training Trajectories (MTT) [9], applicants calculated performance based on the average test accuracy across 100 networks rather than relying on the best result reported in the paper. There was an attempt to reproduce prior methods that did not conduct experiments on some datasets by following the released author codes. However, for methods that encountered scalability issues on high-resolution datasets, Applicants were unable to obtain the relevant performance scores.

TABLE 9
Class listings for the ImageNet subsets.

| Dataset | 0 | 1 | 2 | 3 | 4 | 5 | 6 | 7 | 8 | 9 |
|---|---|---|---|---|---|---|---|---|---|---|
| ImageNette [ [symbol] ] | Tench | English | Cassette | Chainsaw | Church | French | Garbage | Gas | Golf | Parachute |
| | | Springer | Player | | | Horn | Truck | Pump | Ball | |
| ImageWoof [ [symbol] ] | Australian | Border | Samoyed | Beagle | Shih-Tzu | English | Rhodesian | Dingo | Golden | English |
| | Terrier | Terrier | | | | Foxhound | Ridgeback | | Retriever | Sheepdog |
| ImageSquawk [ [symbol] ] | Peacock | Flamingo | Macaw | Pelican | King | Bald | Toucan | Ostrich | Black | Cockatoo |
| | | | | | Penguin | Eagle | | | Swan | |

[symbol]

indicates data missing or illegible when filed

Hyperparameters: In order to ensure that the methodology can be reproduced, applicants have included a Table 10 listing all the hyperparameters used in this work. For the baseline methods, applicants utilized the default parameters that the authors specified in their original papers.

Applicants used the same hyperparameter settings across all experiments unless otherwise stated. Specifically, applicants employed an SGD optimizer with a learning rate of 1 for learning synthetic sets and a learning rate of 0.01 for training neural network models. For low-resolution datasets, applicants used a 3-layer ConvNet, while for medium- and high-resolution datasets, applicants followed the recommendation of and used a 4-layer and 5-layer ConvNet, respectively. In all experiments, applicants used a mini-batch of 256 real images from each class to learn the synthetic set.

Additionally, applicants conducted ablation studies on certain hyperparameters, such as task balance λ and the power parameter p in the Spatial Attention Matching (SAM) modules.

### Additional Results and Further Analysis

Comparison to More Baselines: Applicants conducted a comparison between images created by the DataDAM and popular generative models such as variational auto-encoders (VAEs) [28, 39] and generative adversarial networks (GANs) [20, 36, 6, 34] to evaluate their data efficiency. For this purpose, applicants selected state-of-the-art models, including the DC-VAE [39], cGAN [36], BigGAN [6], and GMMN [34]. The DC-VAE generates a model with dual contradistinctive losses, which improves the generative autoencoder's inference and synthesis abilities simultaneously. The cGAN model is conditioned on both the generator and discriminator, while BigGAN uses differentiable augmentation techniques [62]. On the other hand, GMMN aims to learn an image generator that can map a uniform distribution to a real image distribution.

Applicants trained these models on the CIFAR10 dataset with varying numbers of images per class (1, 10, and 50 IPCs) using ConvNet's (3-layer) architecture and evaluated their performance on real testing images. The results, presented in Table 11, indicate that the proposed method significantly outperforms these generative models. The DataDAM generates superior training images that offer more informative data for training DNNs, while the primary goal of the generative models is to create realistic-looking images that can deceive humans.

Therefore, the efficiency of images produced by generative models is similar to that of randomly selected coresets. Applicants also employed another baseline approach, which is learning synthetic images through distribution matching using vanilla maximum mean discrepancy (MMD) in the pixel space. By utilizing MMD loss with a linear kernel, applicants achieved improved performance compared to randomly selected real images and generative models (see Table 11). However, DataDAM surpasses the results of vanilla MMD since it generates more informative synthetic images by utilizing the information of the feature extractor at various levels of representation.

TABLE 10

| Hyperparameters | | | Optional | |
|---|---|---|---|---|
| Category | Parameter Name | Description | Range | Value |
| Optimization | Learning Role ηs (images) | [symbol] | (0, 10.0) | IPC ≤ 50 [symbol] 1.0 |
| | Learning Role ηs (network) | [symbol] | (1, 1.0) | IPC > 50 [symbol] 10.0 |
| | Optimizer (images) | [symbol] | 5GD with | Momentum: 0.5 |
| | | | Momentum | Weight Decay: 0.9 |
| | Optimizer (network) | [symbol] | 5GD with | Momentum: 0.9 |
| | | | Momentum | Weight Decay [symbol] |
| | Scheduler (images) | — | — | — |
| | Scheduler (network) | [symbol] | StepLR | [symbol] |
| | [symbol] | [symbol] | (1, ∞) | [symbol] |
| Loss Function | Task Balance Å | [symbol] | (0, ∞) | Low Resolution [symbol] |
| | | | | High Resolution [symbol] |
| | Power Value ρ | [symbol] | (1, ∞) | 4 |
| | [symbol] | [symbol] | — | [symbol] |
| | [symbol] Type | [symbol] | — | 1.2 |
| DSA Augmentations | [symbol] | [symbol] | brightness | 1.0 |
| | | | saturation | 2.0 |
| | | | contrast | 0.5 |
| | [symbol] | [symbol] | [symbol] crop pod | 0.125 |
| | [symbol] | [symbol] | [symbol] ratio | 0.5 |
| | Flip | [symbol] | (0, 1.0) | 0.5 |
| | Scole | [symbol] | scaling ratio | 1.2 |
| | [symbol] | [symbol] | 0°-300° | [−15°, +15°] |
| Encoder Parameters | [symbol] Layer Weights | [symbol] | [symbol] | [symbol] |
| | Activation Function | [symbol] | — | [symbol] |
| | Normalization Layer | [symbol] | — | [symbol] |

[symbol]

indicates data missing or illegible when filed

TABLE 11
Comparison of the DataDAM's performance to popular generative
models and the MMD baseline on the CIFAR10 dataset using ConvNets.
The “Random” category denotes randomly selected real images.

| IPC | Random | DC-VAE | cGAN | BigGAN | GMMN | MMD | DataDAM |
|---|---|---|---|---|---|---|---|
| 1 | 14.4 ± 2.0 | 15.7 ± 2.1 | 16.3 ± 1.4 | 15.8 ± 1.2 | 16.1 ± 2.0 | 22.7 ± 0.6 | 32.0 ± 1.2 |
| 10 | 26.0 ± 1.2 | 29.8 ± 1.0 | 27.9 ± 1.1 | 31.0 ± 1.4 | 32.2 ± 1.3 | 34.9 ± 0.3 | 54.2 ± 0.8 |
| 50 | 43.4 ± 1.0 | 44.0 ± 0.8 | 43.8 ± 0.9 | 46.2 ± 0.9 | 45.3 ± 1.0 | 50.9 ± 0.3 | 67.0 ± 0.4 |

### More Ablation Studies

Evaluation of power parameter p in the SAM module: An examination how the p-norm impacts the efficiency of spatial-wise attention maps in the SAM module is conducted.

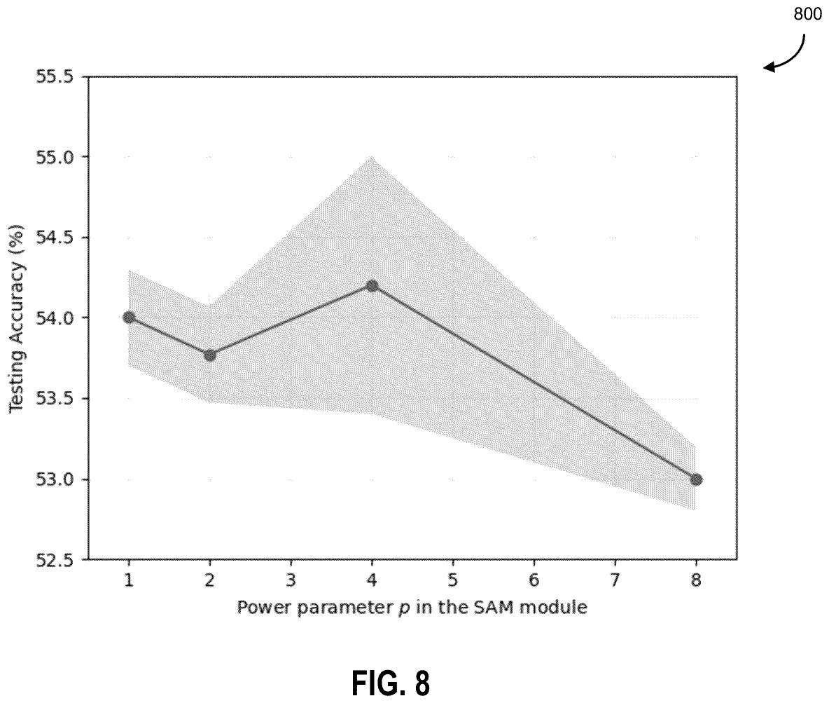

In FIG. 8, Applicants evaluate the testing accuracy of the DataDAM on CIFAR10 with IPC 10 for various values of p as shown in 800. FIG. 8 is a graph showing the effect of the power parameter p on the final testing accuracy (%) for the CIFAR10 dataset with IPC 10 configuration.

The method proves to be robust across a broad range of p values, indicating that it is not significantly affected by changes in the degree of discrepancy measured by LSAM. However, when the power is raised to 8, the DataDAM gives more weight to spatial locations that correspond to the neurons with the highest activations. In other words, it prioritizes the most discriminative parts, potentially ignoring other important components that may be crucial in approximating the data distribution. This could negatively impact the testing performance to some extent.

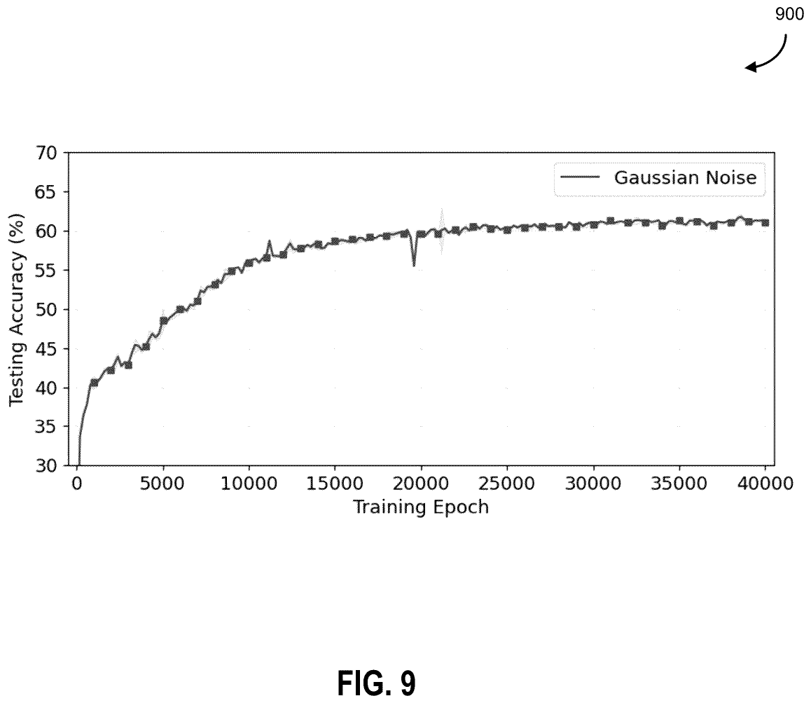

Exploring the effect of Gaussian noise initialization for synthetic images on DataDAM: To augment the results noted above, Applicants present an extended training configuration for initialization from Gaussian noise. Applicants conducted this experiment on CIFAR10 with IPC 50. As seen in FIG. 9, the Gaussian noise initialization approach shown in 900 takes longer to converge to a competitive accuracy level. Despite underperforming in comparison to Random and K-Center initialization, it still demonstrates the ability of the proposed method to distill information from the real dataset onto pure random noise. FIG. 9 is a graph showing test accuracy evolution of synthetic image learning on CIFAR10 with IPC 50 under Gaussian noise initialization.

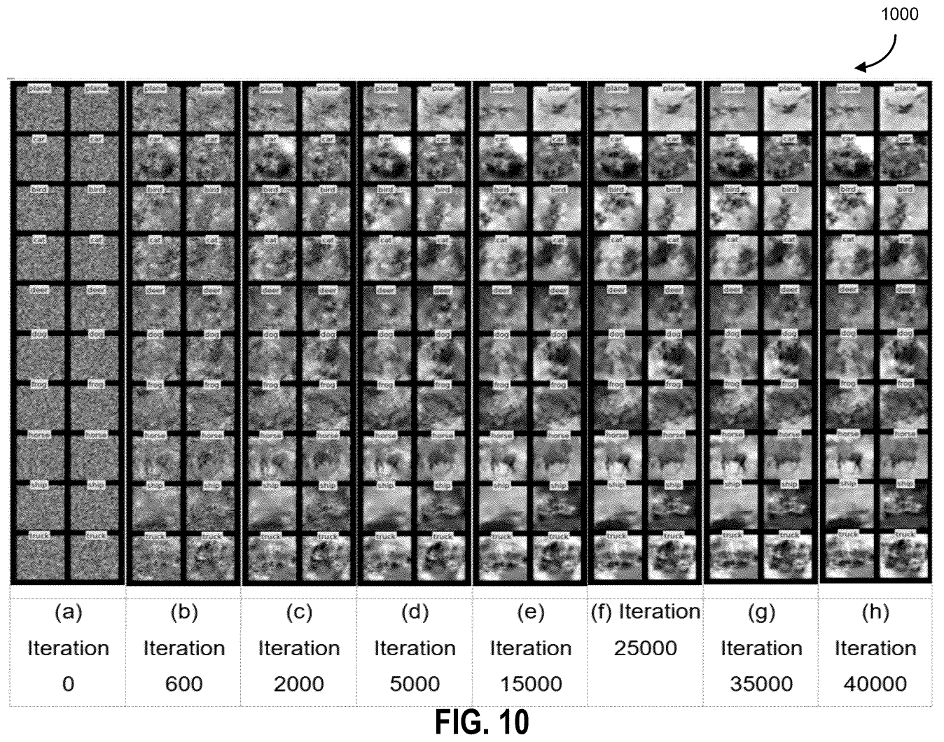

Moreover, it is capable of outperforming competitive methods, particularly KIP [37] and DSA [62]. In FIG. 10, Applicants provide visualizations 1000 of the synthetic data generated from random noise during different iterations. These visualizations highlight how the method successfully transfers information from the real dataset to the random noise, especially when comparing the initial noise image with the final iteration. FIG. 10 is a graph showing the learning process of all classes in the CIFAR10 dataset (IPC 50) initialized from Gaussian noise. Applicants take two random images for each class and visualize their progression over the 40,000 training epochs.

Exploring the effect of different augmentation strategies in DataDAM. Applicants explore the impact of augmentation methods on the effectiveness of the approach when evaluated on the CIFAR10 dataset with an IPC 10 configuration. Applicants treat the method as a black box, as in the work of [13], and assess the effects of various augmentation techniques such as AutoAugment [11], RandAugment [12], DSA [62], and no augmentation on the distilled datasets during the evaluation phase.

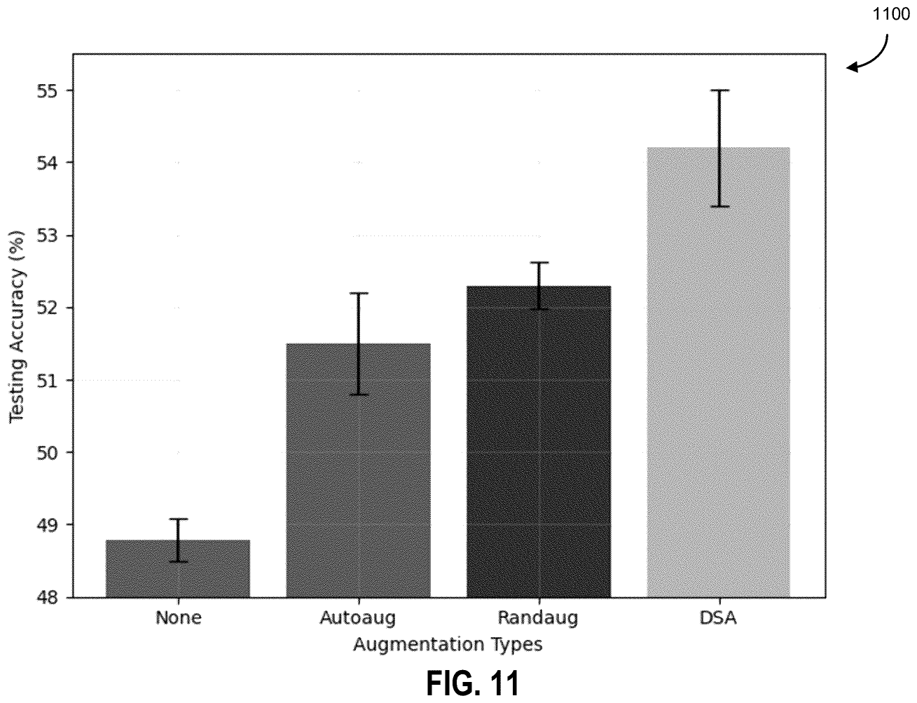

The results 1100 are presented in FIG. 11. FIG. 11 is a graph showing the effect of different augmentation strategies during the evaluation phase on the final testing accuracy (%) for the CIFAR10 dataset with IPC 10 configuration.

The observations reveal that DSA delivers significantly better performance as it is integrated into the training process of the synthetic dataset and is more compatible with the learning phase of the distilled images. Additionally, the findings indicate that augmentation is vital for training on synthetic data, as evidenced by the substantial differences between different augmentation methods and no augmentation. Therefore, applying augmentation techniques to the distilled images during evaluation can substantially enhance model performance.

Exploring the effect of different loss configurations in LSAM. In this section, applicants explore the impact of different loss configurations on attention loss (LSAM). To conduct this evaluation, applicants employed mean absolute error (MAE), cosine dissimilarity, and mean square error (MSE) as objective functions for LSAM to train a synthetic dataset on CIFAR10 with IPC 10.

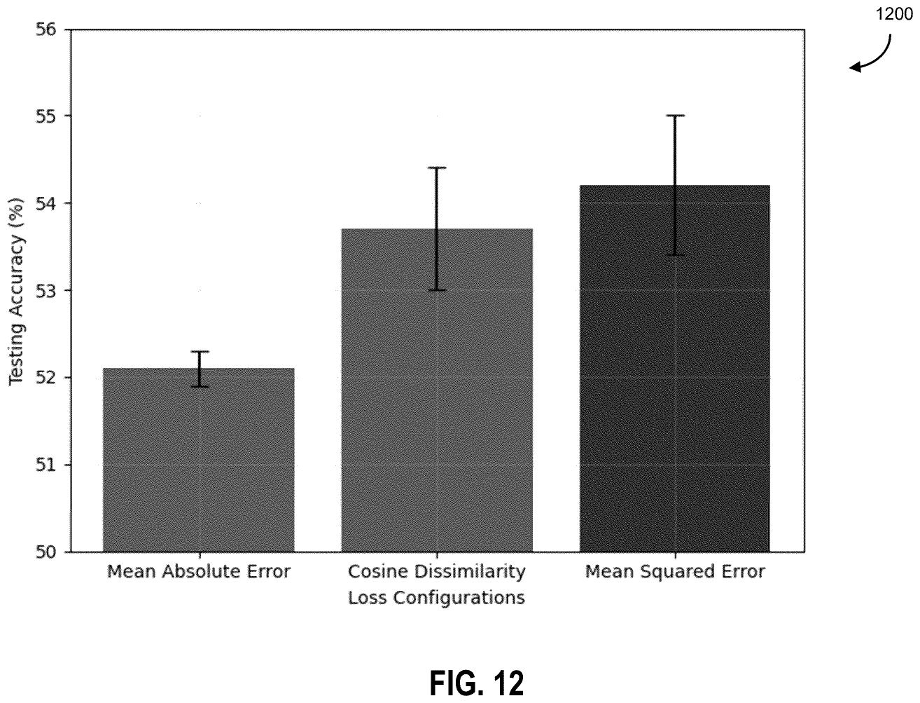

The results 1200 presented in FIG. 12 demonstrate that MSE yields the best results. Nonetheless, it is crucial to note that even with any of these configurations, the method still outperforms most of the competitive methods (except the MTT [9]). Therefore, applicants can conclude that the approach performs well with any loss configuration, but a well-designed configuration can result in a substantial performance improvement of up to 2.0% in the ablation study.

FIG. 12 is a graph showing the effect of loss configurations of LSAM on the final testing accuracy (%) for the CIFAR10 dataset with IPC 10 configuration.

Exploring the effect of normalization in the SAM module: Applicants aim to evaluate the impact of the normalization block in the internal structure of the SAM module on testing accuracy. Applicants conducted experiments by training distilled images for CIFAR10 with IPC 10 and testing three normalization techniques: L1 normalization, L2 normalization, and no normalization.

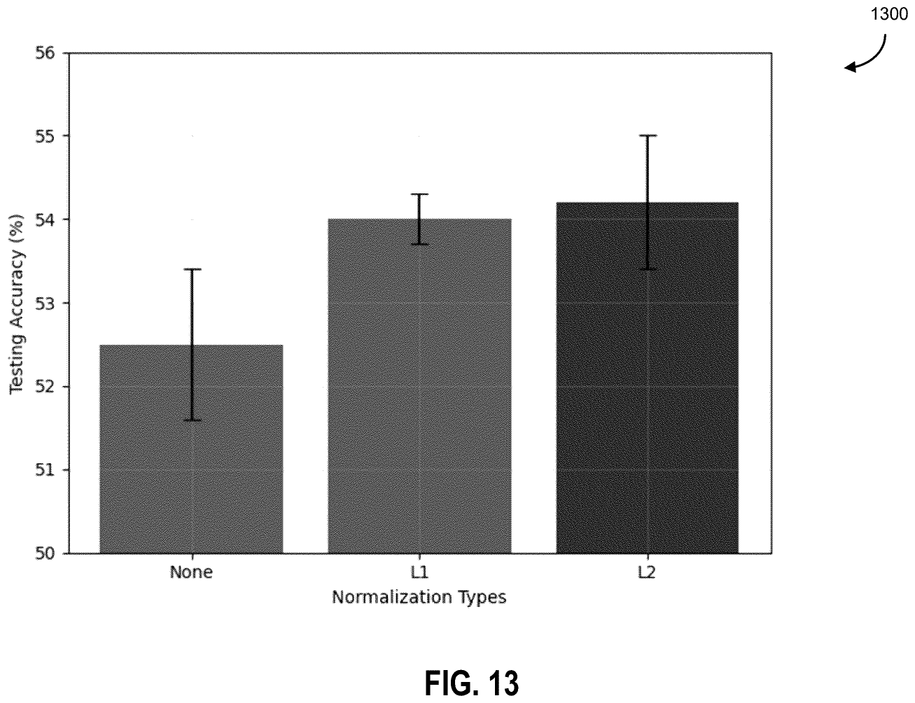

The results 1300, as shown in FIG. 13, indicate that L2 normalization is the most effective in terms of testing accuracy. FIG. 13 is a graph showing the effect of different normalization blocks of the SAM module on the final testing accuracy (%) for the CIFAR10 dataset with IPC 10 configuration. By adding normalization, applicants reduce the magnitude of the attention loss LSAM in backpropagation, thus decreasing the chance of overshooting the global minima in the optimization space when modifying the input image's pixels. Applicants can observe that both normalization schemes work well, but the absence of normalization leads to significant performance degradation. Therefore, Applicants conclude that while the appropriate use of normalization is critical for the performance of the DataDAM, the type of normalization is not as significant.

Taking inspiration from [64, 62, 63], Applicants define a search space consisting of 720 ConvNets on the CIFAR10 dataset.

Applicants evaluate the models using the distilled data with IPC 50 as a proxy set under the neural architecture search (NAS) framework.

Applicants start with a base ConvNet and construct a uniform grid that varies in depth D ∈ {1, 2, 3, 4}, width W E {32, 64, 128, 256}, activation function A E {Sigmoid, ReLu, LeakyReLu}, normalization technique N E {None, BatchNorm, LayerNorm, InstanceNorm, GroupNorm}, and pooling operation P E {None, MaxPooling, AvgPooling}.

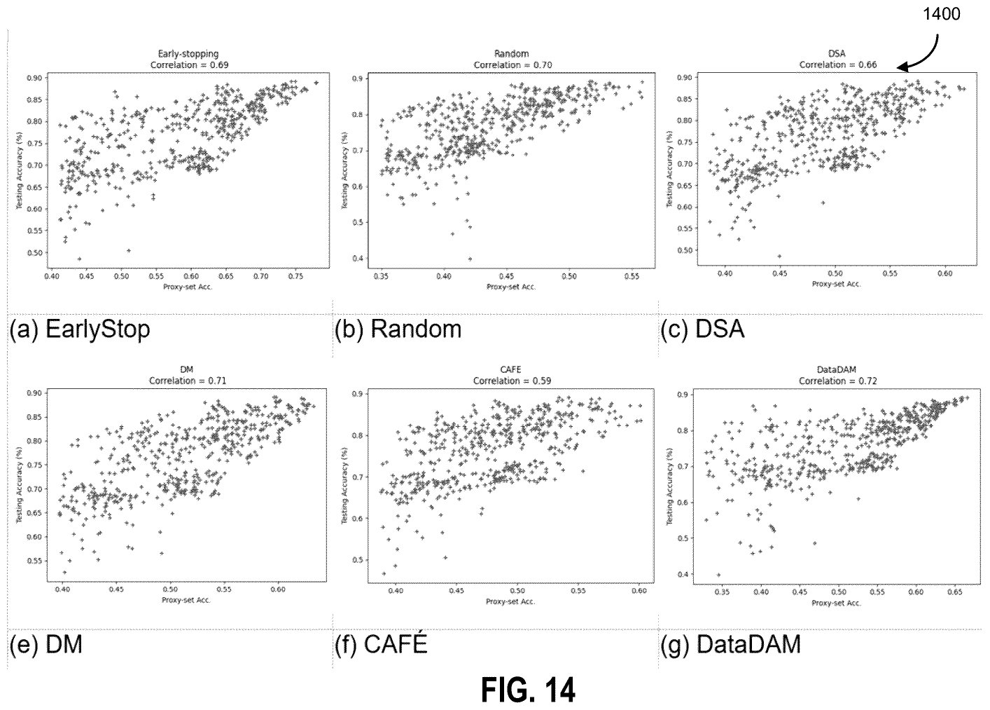

These candidates are then evaluated based on their validation performance and ranked accordingly. In the charts 1400 of FIG. 14, Applicants display the performance rank correlation between the proxy set, generated using various methods, and the whole training dataset using Spearman's correlation across all 720 architectures. FIG. 14 shows performance rank correlation between proxy set and whole dataset training across all 720 architectures.

Each point in the graph represents a selected architecture. The x-axis represents the test accuracy of the model trained on the proxy set, while the y-axis represents the accuracy of the model trained on the whole dataset. The analysis shows that all methods perform well.

However, DataDAM has a higher concentration of dots close to the straight line, indicating a better proxy set for obtaining more reliable performance rankings of candidate architectures. These results are on par with the DataDAM's performance correlation (0.72), which is higher than other prior works.

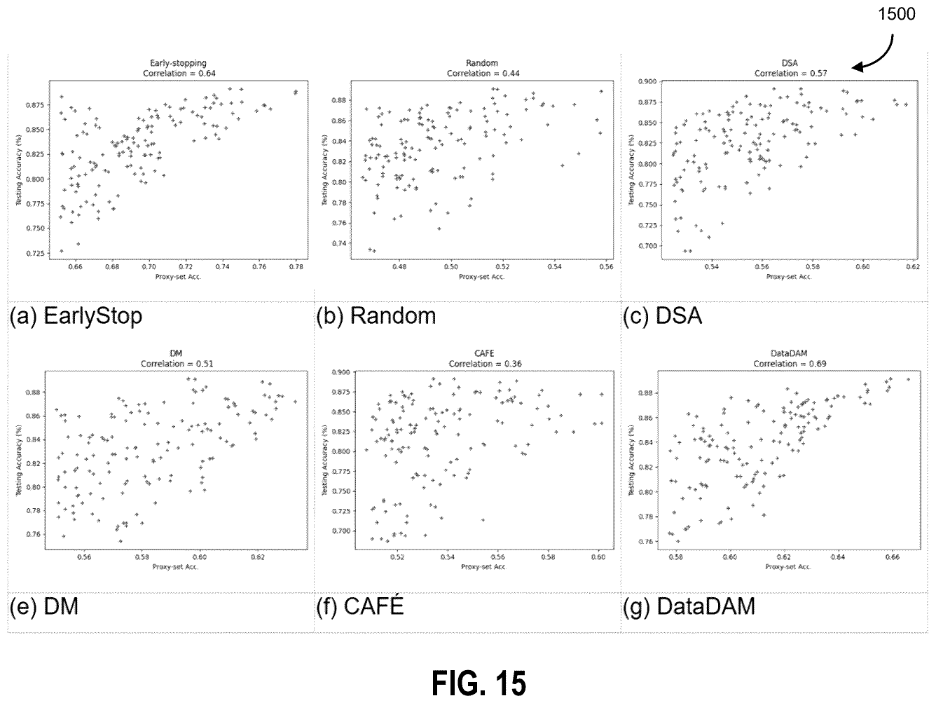

To further assess the effectiveness of the approach, applicants conducted an analysis of the top 20% of the search space, selecting 144 architectures with the highest validation accuracy. As depicted in the charts 1500 of FIG. 15, the method outperforms most of the state-of-the-art methods, except for early stopping, where applicants only beat it by a small margin. The evaluation of the correlation graphs indicates that DataDAM is capable of accurately correlating the performance of models trained on the proxy dataset with their performance on the whole training dataset. Applicants substantiate these findings by presenting quantitative results of performance and Spearman's correlation in Table 12.

FIG. 15 is a graph showing performance rank correlation between proxy-set and whole-dataset training across the top 20% of the search space (selecting 144 architectures with the highest validation accuracy).

TABLE 12
Neural architecture search on CIFAR10 with a search space of the
top 20% of the sample space with the highest validation accuracy.

| | | | | | | Early- | Whole |
|---|---|---|---|---|---|---|---|
| | Random | DSA | DM | CAFE | Ours | stopping | Dataset |
| Performance (%) | 88.9 | 87.2 | 87.2 | 83.6 | 89.0 | 88.9 | 89.2 |
| Correlation Top 20% | 0.44 | 0.57 | 0.51 | 0.36 | 0.69 | 0.64 | 1.00 |
| Time cost (min) | 33.0 | 31.2 | 32.2 | 30.7 | 34.8 | 37.1 | 5168.9 |
| Storage (imgs) | 500 | 500 | 500 | 500 | 500 | 5 × 10⁴ | 5 × 10⁴ |

Experiments on NAS-Bench-201. To conduct a more comprehensive analysis of the neural architecture search, applicants expanded the search space by including NAS-Bench201 as recommended in [13]. The aim is to compare the performance of DataDAM against other methods using the CIFAR10 dataset with IPC 50 as the proxy set. To create a search space, applicants randomly selected 100 networks from the 15,635 available models in NAS-Bench-201.

Applicants followed the configuration and settings presented in which involve training all models using five random seeds and ranking them based on their average accuracy on a validation set comprising 10,000 images. Applicants used two metrics to evaluate the effectiveness of NAS: the performance correlation ranking between models trained on synthetic and real datasets and the top-1 performance in the search space. In contrast to the previous search space that concentrated on 720 ConvNet architectures, applicants observed a distinct trend in this larger NAS benchmark with modern architectures. According to Table 13, while most methods achieved negative correlations between performance on the proxy set and the entire dataset, the method had a small positive correlation and obtained competitive outcomes on the original dataset. This implies that DataDAM preserves the true strength of the underlying model more effectively than previous works.

Nevertheless, despite the encouraging performance gains achieved by the best single model, utilizing the distilled data to guide model design remains a significant challenge. It is important to mention that the rank correlation presented in Table 13 for the original real dataset is not 1.0. This is because a smaller architecture was used and the ranking was based on a validation set, as pointed out in [13].

TABLE 13
Spearman's rank correlation results were obtained using NAS-Bench-201.
The best performance achieved on the test set is 94.36% [13].

| | | | | | | | | Whole |
|---|---|---|---|---|---|---|---|---|
| | Random | DC | DSA | DM | KIP | MTT | DataDAM | Dataset |
| Correlation | −0.06 | −0.19 | −0.37 | −0.37 | −0.50 | −0.09 | 0.07 | 0.7487 |
| Top 1 (%) | 91.9 | 86.44 | 73.54 | 92.16 | 92.91 | 73.54 | 93.96 | 93.5 |

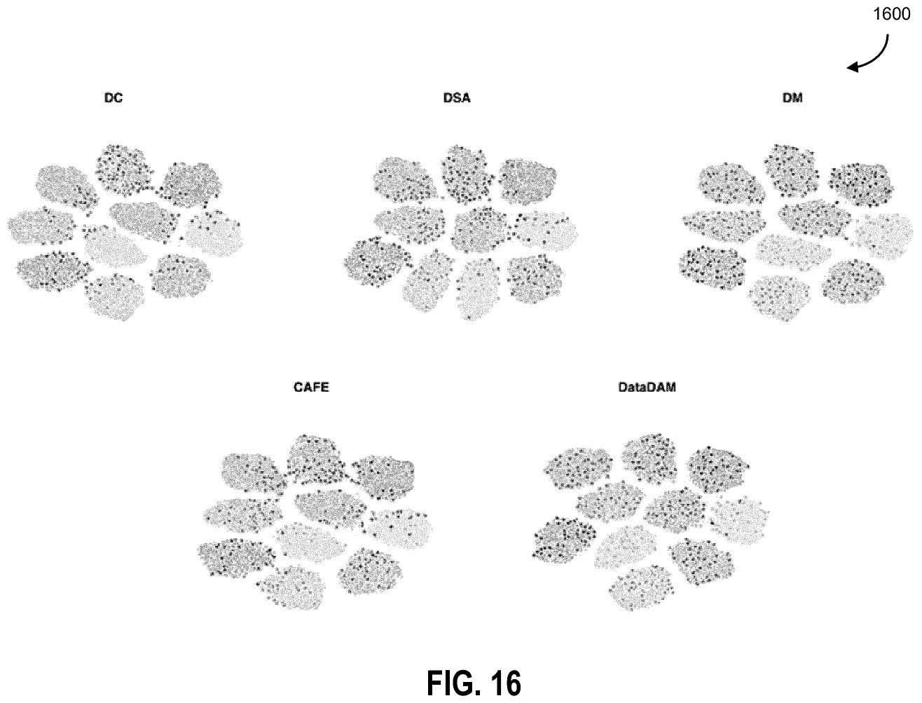

To complement the data distribution visualization results presented herein, Applicants have included t-SNE illustrations 1600 for all categories in FIG. 16. Applicants utilized t-SNE to show the features of real and synthetic sets generated by DC [64], DSA [62], DM [63], CAFE [52], and DataDAM in the embedding space of the ResNet-18 architecture. The visualizations were applied to the CIFAR10 dataset with IPC 50 for all methodologies. FIG. 16 shows distributions of the synthetic images learned by five methods on the CIFAR10 dataset with IPC 50. The stars represent the synthetic data dispersed amongst the original dataset. The classes are as follows: plane, car, bird, cat, deer, dog, frog, horse, ship, truck.

As depicted in FIG. 16, the approach, similar to DM, preserves the distribution of data with a well-balanced spread over the entire dataset. Conversely, other methods, such as DC, DSA, and CAFE, exhibit a significant bias toward the boundaries of certain clusters and have high false-positive rates for the majority of the classes.

To put it simply, the t-SNE visualization validates that the method maintains a considerable degree of impartiality in accurately capturing the dataset distribution uniformly across all categories.

Visualization of the synthetic images trained with different model architectures in DataDAM are shown in this section. Applicants present a qualitative comparison of the generated distilled images using different architectures to demonstrate how the choice of architecture influences the quality of the synthetic set.

Applicants assess the efficacy of the distilled data trained using ConvNet [18], AlexNet [30], and VGG-11 architectures on the CIFAR10 dataset with IPC 50. The results reveal that the distilled data can encode the inductive bias of the chosen architecture. Specifically, the distilled images produced by the simplest architecture, i.e., ConvNet [18], exhibit a natural appearance and can transfer well to other architectures (see Table 3). In contrast, the distilled images generated by modern architectures like VGG-11 exhibit different brightness and contrast than natural images. Applicants found that increasing the complexity and number of convolutional layers in the feature extraction process led to brighter and more contrasting distilled images. This is likely because the attention loss (LSAM) becomes more potent, resulting in a more substantial modulation effect on the input image pixels during backpropagation. This trend is noticeable in the distilled images generated by AlexNet and VGG-11 [47]. Applicants note that the synthetic images may reflect the similarity between architectures, as evidenced by the similarity between the images produced by AlexNet and ConvNet. This finding suggests that the inductive biases of these two architectures are comparable.

Visualization of the synthetic images trained with different loss components in DataDAM is shown in this section. It involves a comparison of the synthetic images generated by utilizing different loss objectives, namely only LMMD, only LSAM, layer-wise feature map transfer loss, and the DataDAM loss. The CIFAR10 dataset with IPC 10 was used for this evaluation to qualitatively assess the contribution of each loss component. The visualization of DataDAM is a linear combination of the LSAM and LMMD visualizations, resulting in a brighter and more contrasted image compared to each loss component individually. The generated synthetic sets by LSAM and layer-wise feature transfer loss are somewhat similar since both losses match the information of feature maps generated by the real and synthetic datasets. However, the images distilled by LSAM are brighter and more contrasted due to the matching of the most discriminative parts of the images.

Applicants conducted an experiment to analyze the distilled images produced by matching different layers of the ConvNet on real and synthetic datasets, showing visualization of the synthetic images trained with different layers in DataDAM. The study focused specifically on the CIFAR10 dataset with IPC 10. During testing, it was demonstrated that the layers performed differently as each layer conveyed distinct information regarding the data distributions.

The approach, DataDAM, utilizes all intermediate and final layers, resulting in distilled images that possess greater brightness and contrast. This is primarily due to the matching of attention maps in each layer as well as the embedding representation of the final layer.

Visualization of the synthetic images trained with different initialization strategies in DataDAM is shown in this section.

Applicants presented the distilled images for the CIFAR10 dataset generated by IPC 50 using three distinct initialization methods: Random, K-Center [46, 13], and Gaussian noise. Applicants observed the learned representations of the synthesis images produced using each initialization strategy, and noted a striking resemblance between the distilled images obtained through Random and K-Center initialization, which further confirms the results presented. In contrast, the images generated using Gaussian noise initialization have noticeable differences in comparison to others, but they have still been learned effectively, and they contain crucial information for each class.

In summary, these qualitative observations provide additional evidence that the model is robust enough to handle variations in initialization conditions.

What is claimed is:

1. A computer system for distilling a first input dataset to generate a condensed synthetic dataset, the computer system comprising:
a computer processor operating in conjunction with computer memory and a non-transitory computer readable data storage, the computer processor configured to:
initialize a learnable synthetic dataset with synthetic image and label pairs;
instantiate a plurality of randomly initialized deep neural networks having L layers configured to embed both the first input dataset and the learnable synthetic dataset;
for each class present in the first input dataset, sample a batch of real and synthetic data from the first input dataset and the learnable synthetic dataset and generate a first feature map for the first input dataset and a second feature map for the learnable synthetic dataset, each feature map having feature arrays corresponding to each layer of the L layers;
generate a pair of attention maps using a feature-based mapping function that takes feature arrays of a plurality of layers of the L layers as an input, the pair of attention maps including a first attention map for the first input dataset and a second attention map for the learnable synthetic dataset;
update the learnable synthetic dataset to learn condensed synthetic dataset the based at least on a comparison of the pair of attention maps using a loss function to approximate a distribution of the first input dataset; and
generate the condensed synthetic dataset as an output data object.

2. The system of claim 1, wherein the first input data set and the condensed synthetic data set are both high-dimensionality image datasets.

3. The system of claim 1, wherein the first input data set is provided through electronic communication by a data pipeline.

4. The system of claim 1, wherein the condensed synthetic data set is provided to a coupled machine learning model training engine, the coupled machine learning model training engine using the condensed synthetic data set to train parameters of a target machine learning model.

5. The system of claim 4, wherein the coupled machine learning model training engine is configured for continuous training, and the condensed synthetic dataset is generated based on a training dataset that was used previously to train the target machine learning model to reduce catastrophic forgetting effects.

6. The system of claim 4, wherein the coupled machine learning model training engine is operating on a portable device with limited computing resources, the condensed synthetic dataset allowing training using the limited computing resources due to compression relative to the first input data set.

7. The system of claim 1, wherein the condensed synthetic data set is provided to a coupled machine learning model training engine, the coupled machine learning model training engine using the condensed synthetic data set to train parameters of a plurality of target machine learning models, the plurality of target machine learning models representing different candidate machine learning architectures, wherein a highest performing candidate machine learning architecture is automatically selected for coupling to a downstream production system.

8. The system of claim 1, wherein the first input data set is a shard portion of a larger dataset used for federated learning and the condensed synthetic dataset is provided as a federated learning input into a downstream federated learning engine that trains a target machine learning model using a combination of condensed synthetic datasets each corresponding to a corresponding shard portion of the larger dataset.

9. The system of claim 1, wherein the first input data set includes personal or sensitive information relating to one or more entities, and the condensed synthetic dataset does not include the personal or sensitive information relating to one or more entities.

10. The system of claim 1, wherein computer system is a special purpose computing appliance residing within a data center and coupled to a message bus, the message bus providing the first input dataset through electronic communication with a data source and transmitting the condensed synthetic dataset to a coupled machine learning model training engine.

11. A method for distilling a first input dataset to generate a condensed synthetic dataset, the method comprising:
initializing a learnable synthetic dataset with synthetic image and label pairs;
instantiating a plurality of randomly initialized deep neural networks having L layers configured to embed both the first input dataset and the learnable synthetic dataset;
for each class present in the first input dataset, sampling a batch of real and synthetic data from the first input dataset and the learnable synthetic dataset and generate a first feature map for the first input dataset and a second feature map for the learnable synthetic dataset, each feature map having feature arrays corresponding to each layer of the L layers;
generating a pair of attention maps using a feature-based mapping function that takes feature arrays of a plurality of layers of the L layers as an input, the pair of attention maps including a first attention map for the first input dataset and a second attention map for the learnable synthetic dataset;
updating the learnable synthetic dataset to learn condensed synthetic dataset the based at least on a comparison of the pair of attention maps using a loss function to approximate a distribution of the first input dataset; and
generating the condensed synthetic dataset as an output data object.

12. The method of claim 11, wherein the first input data set and the condensed synthetic data set are both high-dimensionality image datasets.

13. The method of claim 11, wherein the first input data set is provided through electronic communication by a data pipeline.

14. The method of claim 11, wherein the condensed synthetic data set is provided to a coupled machine learning model training engine, the coupled machine learning model training engine using the condensed synthetic data set to train parameters of a target machine learning model.

15. The method of claim 14, wherein the coupled machine learning model training engine is configured for continuous training, and the condensed synthetic dataset is generated based on a training dataset that was used previously to train the target machine learning model to reduce catastrophic forgetting effects.

16. The method of claim 14, wherein the coupled machine learning model training engine is operating on a portable device with limited computing resources, the condensed synthetic dataset allowing training using the limited computing resources due to compression relative to the first input data set.

17. The method of claim 11, wherein the condensed synthetic data set is provided to a coupled machine learning model training engine, the coupled machine learning model training engine using the condensed synthetic data set to train parameters of a plurality of target machine learning models, the plurality of target machine learning models representing different candidate machine learning architectures, wherein a highest performing candidate machine learning architecture is automatically selected for coupling to a downstream production system.

18. The method of claim 11, wherein the first input data set is a shard portion of a larger dataset used for federated learning and the condensed synthetic dataset is provided as a federated learning input into a downstream federated learning engine that trains a target machine learning model using a combination of condensed synthetic datasets each corresponding to a corresponding shard portion of the larger dataset.

19. The method of claim 11, wherein the first input data set includes personal or sensitive information relating to one or more entities, and the condensed synthetic dataset does not include the personal or sensitive information relating to one or more entities.

20. A non-transitory computer readable medium or computer program product storing machine interpretable instructions, which when executed by a processor, cause the processor to perform a method for distilling a first input dataset to generate a condensed synthetic dataset, the method comprising:
initializing a learnable synthetic dataset with synthetic image and label pairs;
instantiating a plurality of randomly initialized deep neural networks having L layers configured to embed both the first input dataset and the learnable synthetic dataset;
for each class present in the first input dataset, sampling a batch of real and synthetic data from the first input dataset and the learnable synthetic dataset and generate a first feature map for the first input dataset and a second feature map for the learnable synthetic dataset, each feature map having feature arrays corresponding to each layer of the L layers;
generating a pair of attention maps using a feature-based mapping function that takes feature arrays of a plurality of layers of the L layers as an input, the pair of attention maps including a first attention map for the first input dataset and a second attention map for the learnable synthetic dataset;
updating the learnable synthetic dataset to learn condensed synthetic dataset the based at least on a comparison of the pair of attention maps using a loss function to approximate a distribution of the first input dataset; and
generating the condensed synthetic dataset as an output data object.
